(19) United States
(12) Patent Application Publication
(10) Pub. No.: US 2020/0184524 A1
(43) Pub. Date: Jun. 11, 2020

(54) IMPROVED TRANSACTIONAL PLATFORM

(71) Applicants: Rolf HERKEN, San Francisco, CA (US); MINE ZERO Gmnh, Berlin (DE)

(72) Inventors: ROLF HERKEN, San Francisco, CA (US); ATTILA VASS, Sao Francisco, CA (US); JOCHEN KORNITZKY, San Francisco, CA (US); ROLF BERTEIG, San Francisco, CA (US); LAWRENCE G. TESLER, San Francisco, CA (US)

(21) Appl. No.: 16/620,498

(22) PCT Filed: Jun. 7, 2018
(86) PCT No.: PCT/US18/36556

§ 371 Date: Dec. 7, 2019

Related U.S. Application Data
(63) Continuation-in-part of application No. PCT/US2016/022232, filed on Mar. 12, 2016.
Application No. PCT/US2016/022232 is a continuation-in-part of application No. 15/557,229, filed on Sep. 11, 2017.
(60) Provisional application No. 62/516,593, filed on Jun. 7, 2017.
(60) Provisional application No. 62/132,489, filed on Mar. 12, 2015.
(60) Provisional application No. 62/132,489, filed on Mar. 12, 2015.

(51) Int. Cl. G06Q 30/06; H04L 29/06; G06Q 50/00; G06Q 30/02; G06Q 30/08; G06Q 20/08; G06Q 20/38; G06Q 20/40; G06Q 50/26; H04L 29/08

(52) U.S. Cl. CPC G06Q 30/0605; H04L 63/062; G06Q 50/01; G06Q 30/0206; G06Q 30/08; H04W 12/0013; G06Q 20/3829; G06Q 20/4014; G06Q 50/265; H04L 67/141; G06Q 20/0855

(57) ABSTRACT

Methods, systems, devices and computer software/program code products enable a Provider to sell services, content or time to a Consumer via a comminations network, and to be financially compensated for the value of the services, content or time provided, via the network.

### REFERENCE TO RELATED APPLICATIONS AND INCORPORATION BY REFERENCE

This patent application claims the priority benefit of commonly owned U.S. Provisional Pat. App. 62/516,593 filed Jun. 7, 2017, entitled “Improved Transactional Platform” (Atty. Dkt. MNE-117-PR); and is a continuation-in-part (CIP) of commonly owned International Pat. App. PCT/US16/22232 filed Mar. 12, 2016, entitled “Transactional Platform” (Attorney Dkt. MNE-112-PCT) (and corresponding U.S. National Phase application Ser. No. 15/557,229 filed Sep. 11, 2017 (Attorney Dkt. MNE-112-US)), which claim the priority benefit of U.S. Provisional App. for Patent Ser. No. 62/132,489 filed Mar. 12, 2015 (Attorney Dkt. MNE-112-PR); each of which is incorporated by reference herein as if set forth herein in its entirety.

Also incorporated by reference herein as if set forth herein in their entireties are: commonly owned International Pat. App. PCT/US17/47430 filed Aug. 17, 2017 (Attorney Dkt. MNE-114-PCT), which claims the priority benefit of U.S. Provisional App. for Patent Ser. No. 62/376,210 filed Aug. 17, 2016 (Attorney Dkt. MNE-114-PR), both entitled “Multi-Factor Protected Private Key Distribution”; and International Pat. App. PCT/US18/32149 filed May 10, 2018 (Attorney Dkt. MNE-116-PCT), which claims the priority benefit of U.S. Provisional App. for Patent Ser. No. 62/504,211 filed May 10, 2017 (Attorney Dkt. MNE-116-PR), both entitled “Secure Telecommunications and Transactional Platform”.

### FIELD OF THE INVENTION

The present invention relates generally to methods, systems, devices and computer program code products (software) for creating and maintaining a secure telecommunications and transactional platform and network.

### BACKGROUND OF THE INVENTION

There exists a need for platforms and networks for facilitating secure, private telecommunications and transactions, including the offering, providing, selling and purchasing of services, content and time.

The present invention, referred to herein as “ZeitMarket” (ZM), provides, among other aspects, methods, systems, devices and computer program code products (software) for creating and maintaining a secure transactional platform and network for offering, providing, selling and purchasing services, content and time.

Aspects, examples, embodiments and practices of the invention, whether in the form of methods, devices, systems or computer program code products (software) will be described in greater detail below, in conjunction with the attached drawing figures.

### SUMMARY OF THE INVENTION

The present invention provides methods, systems, devices, and computer program code products (software) that enable a provider to sell services, content or time to a consumer, via a digital communications network and to be financially compensated for the value of the services, content or time provided, via the digital communications network.

Methods, systems, devices, and computer software/program code products in accordance with the invention are suitable for implementation or execution in, or in conjunction with, commercially available forms of digital computer network structures or digital communications network structures, including servers and other digital processing resources, and devices that communicate with, through or across such structures, such as commercially available forms of cellphones, smartphones, tablets and other commercially available telecommunications and computing devices. In the aspects of the invention described herein and shown in the accompanying drawings, the methods described are executable by digital processors, which can include processing units such as those in known forms of computer network systems, servers, and devices that communicate with such systems and servers, such as cellphones, smartphones, tablets and other commercially available forms of telecommunications and computing devices.

One aspect, practice or embodiment of the invention comprises a server accessible to a plurality of users through respective client application programs executing on respective client devices capable of communicating with the server via a digital network, the server comprising a digital processing resource, the digital processing resource comprising at least one digital processor, the server being operable to: (A) match a user who offers to provide services, content or time (“Provider”) with a user who wishes to purchase the services, content or time (“Consumer”); (B) calculate a market price for the offered services, content or time of the Provider, the calculation via the server being based in part on a metric of demand for the Provider's services, content or time; (C) receive an indication of the Consumer's request to purchase services, content or time of the Provider at the calculated market price; (D) arrange for payment from the Consumer to the Provider, via the server, for the Provider's service, content or time purchased by the Consumer at the calculated market price; and (E) deliver a communications session containing the service, content or time purchased by the Consumer, from the Provider to the Consumer, via the network.

Another aspect of the invention comprises a communications platform environment supported by the server and organized into three layers, comprising a core platform services layer, a platform modules layer, and a platform applications layer, wherein: the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

Another aspect of the invention comprises a marketplace platform environment supported by the server and organized into three layers, comprising a core platform services layer. a platform modules layer, and a platform applications layer, wherein: the core platform services layer comprises core platform services usable by platform modules or platform applications; the platform modules layer comprises platform-based functional modules operable to utilize selected ones of the core platform services provided by the core services layer, and the platform applications layer comprises platform-based application programs operable to utilize selected ones of the core platform services or platform modules.

Another aspect of the invention comprises an application platform environment supported by the server and organized into three layers, comprising a core platform services layer, a platform modules layer, and a platform applications layer, wherein: the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

In an exemplary aspect of the invention, the platform environment (whether a communications platform environment, marketplace platform environment, or applications platform environment) is operable to enable a User of the platform to create and maintain at least one defined identity (Persona) for use in connection with selected service, content or time transactions enabled by the platform.

In one aspect or practice of the invention, a Persona is a fictional identity.

In another aspect or practice of the invention, a Persona is a real identity.

In yet another aspect of the invention, the platform environment is operable to enable a User to create separate, different, respective Personas for use with different, respective service, content or time transactions or classes of transactions enabled by the platform.

In another aspect, platform-based logical links between a given User identity and a corresponding Persona are established by a platform-based Identity Translation Service (ITS).

In another aspect of the invention, the ITS provides a per-application user ID.

In yet another aspect of the invention, the platform environment is operable to enable advanced communications session routing, using a plurality of communication nodes, to enable a selected high level of protection of transmission routing.

In another aspect of the invention, routing is selected at least in part to minimize connection pattern-based information leakage and behavioral analysis.

In another aspect of the invention, in the platform environment, user verification is managed in accordance with a multi-factor protected private key distribution (MFPPKD) technique. MFPPKD is described in commonly owned International Pat. App. PCT/US17/47430 filed Aug. 17, 2017 (Attorney Dkt. MNE-114-PCT), incorporated herein by reference.

In still another aspect of the invention, the platform environment provides a virtual storage structure (Zeitlocker) operable to store data, the Zeitlocker having temporal, spatial and Persona-level access pattern awareness. such that access to data stored in a given Zeitlocker is enabled only to Personas meeting Zeitlocker owner-defined parameters. In another practice or aspect of the invention, access to data in a given Zeitlocker requires real-time authorization from the Zeitlocker owner.

Another aspect of the invention comprises methods for enabling a provider to sell services, content or time to a consumer and be financially compensated for the value of the services, content or time provided, the methods comprising: configuring a server accessible to a plurality of users through respective client application programs executing on respective client devices capable of communicating with the server via a network, the server comprising a digital processing resource, the digital processing resource comprising at least one digital processor and operating the server to: (A) match a user who offers to provide services, content or time (“Provider”) with a user who wishes to purchase the services, content or time (“Consumer”); (B) calculate a market price for the offered services, content or time of the Provider, the calculation via the server being based in part on a metric of demand for the Provider's services, content or time; (C) receive an indication of the Consumer's request to purchase services, content or time of the Provider at the calculated market price; (D) arrange for payment from the Consumer to the Provider, via the server, for the Provider's service, content or time purchased by the Consumer at the calculated market price; and (E) deliver a communications session containing the service, content or time purchased by the Consumer, from the Provider to the Consumer, via the network.

Another aspect of the invention comprises a method that includes configuring a communications platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer, and the platform applications layer comprises platform-based application programs operable to utilize selected ones of the core platform services or platform modules.

Another aspect of the invention comprises a method that includes configuring a marketplace platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer, and the platform applications layer comprises platform-based application programs operable to utilize selected ones of the core platform services or platform modules.

Another aspect of the invention comprises a method that includes configuring an application platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

Another aspect of the invention comprises a method that includes configuring the platform environment (whether a communications platform, marketplace platform, or applications platform) to be operable to enable a User of the platform to create and maintain at least one defined identity (Persona) for use in connection with selected service, content or time transactions enabled by the platform.

In one aspect of the invention, the Persona is a fictional identity.

In another aspect of the invention, the Persona is a real identity.

Another aspect of the invention comprises a method that includes configuring the platform environment (whether a communications platform, marketplace platform, or applications platform) to be operable to enable a User to create separate, different, respective Personas for use with different, respective service, content or time transactions or classes of transactions enabled by the platform.

Another aspect of the invention comprises a method wherein platform-based logical links between a given User identity and a corresponding Persona are established by a platform-based Identity Translation Service (ITS).

Another aspect of the invention comprises a method wherein the ITS provides a per-application user ID.

Another aspect of the invention comprises a method that includes configuring the platform environment (whether a communications platform, marketplace platform, or applications platform) to be operable to enable to enable advanced communications session routing, using a plurality of communication nodes, to enable a selected high level of protection of transmission routing.

In another aspect of the invention, routing is selected at least in part to minimize connection pattern-based information leakage and behavioral analysis.

Another aspect of the invention comprises a method that includes configuring the platform environment (whether a communications platform, marketplace platform, or applications platform) such that in the platform environment, user verification is managed in accordance with a multi-factor protected private key distribution (MFPPKD) technique.

Another aspect of the invention comprises a method that includes configuring the platform environment (whether a communications platform, marketplace platform, or applications platform) to provide a virtual storage structure, referred to herein as a Zeitlocker, operable to store data, the Zeitlocker having temporal, spatial and Persona-level access pattern awareness, such that access to data stored in a given Zeitlocker is enabled only to Personas meeting Zeitlocker owner-defined parameters.

Another aspect of the invention comprises a method wherein access to data in a given Zeitlocker requires real-time authorization from the Zeitlocker owner.

Another aspect of the invention comprises computer program products (software) for use with a digital processing system for enabling a provider to sell services, content or time to a consumer and be financially compensated for the value of the services, content or time provided, the digital processing system comprising a server, the server comprising at least one digital processor, the server being accessible to a plurality of users through respective client application programs executing on respective client devices operable to communicate with the server via a network, the computer program product comprising digital processor-executable program instructions stored on a non-transitory digital processor-readable medium, which when executed in the digital processor cause the server to: (A) match a user who offers to provide services, content or time (“Provider”) with a user who wishes to purchase the services, content or time (“Consumer”); (B) calculate a market price for the offered services, content or time of the Provider, the calculation via the server being based in part on a metric of demand for the Provider's services, content or time; (C) receive an indication of the Consumer's request to purchase services, content or time of the Provider at the calculated market price; (D) arrange for payment from the Consumer to the Provider, via the server, for the Provider's service, content or time purchased by the Consumer at the calculated market price; and (E) deliver a communications session containing the service, content or time purchased by the Consumer, from the Provider to the Consumer, via the network.

Another aspect of the invention comprises a computer program product comprising digital processor-executable program instructions that, when executed in a digital processor of a server, cause the server to configure a communications platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

Another aspect of the invention comprises a computer program product comprising digital processor-executable program instructions that, when executed in a digital processor of a server, cause the server to configure a marketplace platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

Another aspect of the invention comprises a computer program product comprising digital processor-executable program instructions that, when executed in a digital processor of a server, cause the server to configure an application platform environment supported by the server and organized into three layers, comprising a core platform services layer, a platform modules layer, and a platform applications layer, wherein the core platform services layer comprises core platform services usable by platform modules or platform applications; the platform modules layer comprises platform-based functional modules operable to utilize selected ones of the core platform services provided by the core services layer, and the platform applications layer comprises platform-based application programs operable to utilize selected ones of the core platform services or platform modules.

Another aspect of the invention comprises a computer program product comprising digital processor-executable program instructions that, when executed in a digital processor of a server, cause the server to configure the platform environment (whether a communications platform, marketplace platform, or applications platform) to be operable to enable a User of the platform to create and maintain at least one defined identity (Persona) for use in connection with selected service, content or time transactions enabled by the platform.

In one aspect of the invention, the Persona is a fictional identity.

In another aspect of the invention, the Persona is a real identity.

Another aspect of the invention comprises a computer program product comprising digital processor-executable program instructions that, when executed in a digital processor of a server, cause the server to configure the platform environment (whether a communications platform, marketplace platform, or applications platform) to be operable to enable a User to create separate, different, respective Personas for use with different, respective service, content or time transactions or classes of transactions enabled by the platform.

Another aspect of the invention comprises a computer program product comprising digital processor-executable program instructions that, when executed in a digital processor of a server, cause the server to configure a platform environment in which platform-based logical links between a given User identity and a corresponding Persona are established by a platform-based Identity Translation Service (ITS).

Another aspect of the invention comprises a computer program product comprising digital processor-executable program instructions that, when executed in a digital processor of a server, cause the server to configure a platform environment in which the ITS provides a per-application user ID.

Another aspect of the invention comprises a computer program product comprising digital processor-executable program instructions that, when executed in a digital processor of a server, cause the server to configure the platform environment (whether a communications platform, marketplace platform, or applications platform) to be operable to enable to enable advanced communications session routing, using a plurality of communication nodes, to enable a selected high level of protection of transmission routing.

Another aspect of the invention comprises a computer program product comprising digital processor-executable program instructions that, when executed in a digital processor of a server, cause the server to configure a platform environment in which routing is selected at least in part to minimize connection pattern-based information leakage and behavioral analysis.

Another aspect of the invention comprises a computer program product comprising digital processor-executable program instructions that, when executed in a digital processor of a server, cause the server to configure the platform environment (whether a communications platform, marketplace platform, or applications platform) such that in the platform environment, user verification is managed in accordance with a multi-factor protected private key distribution (MFPPKD) technique.

Another aspect of the invention comprises a computer program product comprising digital processor-executable program instructions that, when executed in a digital processor of a server, cause the server to configure the platform environment (whether a communications platform, marketplace platform, or applications platform) to provide a virtual storage structure, referred to herein as a Zeitlocker, operable to store data, the Zeitlocker having temporal, spatial and Persona-level access pattern awareness, such that access to data stored in a given Zeitlocker is enabled only to Personas meeting Zeitlocker owner-defined parameters.

Another aspect of the invention comprises a computer program product comprising digital processor-executable program instructions that, when executed in a digital processor of a server, cause the server to configure the platform environment such that access to data in a given Zeitlocker requires real-time authorization from the Zeitlocker owner.

These and other aspects, examples, embodiments and practices of the invention, whether in the form of methods, devices, systems or computer software/program code products, will be discussed in greater detail below in the following Detailed Description of the Invention and in connection with the attached drawing figures. Those skilled in the art will appreciate that while the following detailed description provides sufficient detail to enable one skilled in the art to practice the present invention, the various examples, embodiments and practices of the present invention that are discussed and described below, in conjunction with the attached drawing figures, are provided by way of example, and not by way of limitation. Numerous variations, additions, and other modifications or different implementations of the present invention are possible, and are within the spirit and scope of the invention.

### BRIEF DESCRIPTION OF THE DRAWINGS

FIGS. 1-10 are schematic diagrams depicting exemplary embodiments of the invention.

FIGS. 11, 12A and 12B are flowcharts depicting exemplary practices of the invention.

FIG. 13 is a schematic block diagram depicting an exemplary embodiment of the invention.

FIG. 14 is a schematic diagram depicting a form of digital cloud configuration in connection with which the invention may be practiced.

### DETAILED DESCRIPTION OF THE INVENTION

### Roadmap:

This Detailed Description of the Invention is organized as follows:

I. Overview

II. Technical Description and Glossary

III. Pricing (“Zeitprice”) and “Universal Zeitmachine” (UZM) Description

IV. Digital Processing Environment In Which Invention Can Be Implemented

V. Conclusion

### I. OVERVIEW

Various aspects, embodiments and practices of the present invention are referred to herein as “ZeitMarket” (ZM) and “ZeitPlatform” or “Z-Platform” (ZP), and will be described in detail in the following sections.

Reference is also made to commonly owned International Pat. App. PCT/US16/22232 filed Mar. 12, 2016, entitled “Transactional Platform” (Attorney Dkt. MNE-112-PCT) (and corresponding U.S. National Phase application Ser. No. 15/557,229 filed Sep. 11, 2017 (Attorney Dkt. MNE-112-US)); each of which is incorporated by reference herein as if set forth herein in its entirety.

Reference is also made to commonly owned International Pat. App. PCT/US17/47430 filed Aug. 17, 2017 (Attorney Dkt. MNE-114-PCT), entitled “Multi-Factor Protected Private Key Distribution”.

Reference is also made to commonly owned International Pat. App. PCT/US18/32149 filed May 10, 2018 (Attorney Dkt. MNE-116-PCT), entitled “Secure Telecommunications and Transactional Platform.”

Each of the foregoing applications is, along with other commonly owned patent applications listed above, incorporated herein by reference as if set forth herein in its entirety.

### II. TECHNICAL DESCRIPTION AND GLOSSARY

Technical design aspects and exemplary practices of the invention are next set forth, including, among other aspects, a description of pricing (“Zeitprice”) and “Universal Zeitmachine” (UZM) aspects of the invention.

### SUMMARY

Zeitmarket, as described herein, is a social and commercial communications platform and digital marketplace for time. As described in greater detail herein, Zeitmarket utilizes a unique, ultra-high-strength security architecture.
It enables potentially every person connected to the Internet to enter into time-based business transactions as a service provider or as a service consumer.
It provides objective algorithmic determination of relevant parameters for conducting business; in particular a parameter referred to herein as the Zeitprice, the maximum rate for the provider's time, independent of the content of any communication.
It provides a private and secure, mobile and stationary telecommunications infrastructure with security, privacy, reach, and ease of use second to none, for live and pre-recorded audio/video/graphic communication and online and offline text-based communication.
It can be operated as a business enterprise with significant revenue potential. Revenue generation can occur in the form of a percentage of the transaction volume generated by providers in numerous verticals. It is paid for the use of the platform, enabling the providers to conduct their respective businesses.
It can be used to define and establish a rational digital currency based on a fundamental resource: time.

### Introduction

### What is Zeitmarket?

In an exemplary embodiment of the invention, Zeitmarkct, as described in greater detail herein, is a commercial and social platform wherein platform users are enabled to realize and monetize the value of their time. (“Zeit” is a German word meaning time.)

With a cloud-based mobile or desktop app, Zeitmarket users conduct privacy-protected social and commercial, one-on-one and one-to-many, real-time and off-line conversations using speech, video, text, images and other media.

Zeitmarket adds an online dimension to existing client-provider relationships that require secure and private communications.

Zeitmarket facilitates new relationships by matching users who provide services with users who want to consume those services.

Zeitmarket provides an efficient way for users to generate income by sharing their knowledge, advice, expertise, experiences, creativity, performance, or empathy. As providers strive to increase the quality of their contributions, the Zeitprice algorithm raises their maximum price, which feeds back into cultivating a greater spirit of trust and engagement with the consumers of their services and content.

Zeitmarket can generate revenues by charging a percentage on all service fees, in reasonable proportion to operating expenses and in a transparent manner. In return, Zeitmarket provides the digital infrastructure for business transactions among its members and keeps their communications securely encrypted and protected from eavesdropping and data analysis.

### Privacy

A fundamental design aspect of Zeitmarket is to protect user privacy above all else. Secure communication is another fundamental aspect of Zeitmarket, as described in detail below.

### Personas and Anonymity

Users have the option to use their real world identity or one of several anonymous, completely protected fictional identities, each called a persona, chosen by the user to be visible only to a specified set of other personas or to the general public. The consumers of services on Zeitmarket may remain anonymous to the providers. Providers may choose to remain anonymous to their clients.

It is contemplated that the Zeitmarket user database will serve as a link between the social platform's user identity and a billing facility.

### Communication Charges

In one embodiment, any communication other than a conversation with designated Friends is considered a business transaction on Zeitmarket between a provider and a client and is charged for, including text messages and email sent by one persona to another, subject to the detection of certain patterns of behavior as verifiable signs of interest displayed by the recipient.

### Zeitprice

Zeitmarket provides a performance-based automated mechanism for price-setting. Zeitmarket publishes each provider's Zeitprice, a market price that Zeitmarket determines algorithmically based on the provider's Success, a function measuring how well a provider fills more time slots with higher-paying customers. Each seller may choose either to charge the Zeitprice to all buyers or to negotiate with each buyer within the price range below and up to the Zeitprice. The Zeitprice of each provider is determined by a server-based module called the Universal Zeitmachine (UZM). It implements the Zeitprice determination based on data provided by each member's individual Zeitmachine.

### Revenue Sources

Zeitmarket earns revenue by taking a percentage of the fees providers charge consumers for time spent, and by taking a percentage of fees consumers charge advertisers for time spent engaging with ads.

In addition, Zeitmarket may decide to charge some or all users a one-time, monthly or annual subscription fee, possibly in the form of an up-front payment for services or impose time limitations on the use of some of the free platform services such as video communication among friends to reduce the cost of operation if needed. However, such charges and limitations would potentially add friction to the decision to register as a user and to the day-to-day use of the platform.

### Zeitmarket in the Enterprise

The Zeitmarket Corporate Edition is a variant of Zeitmarket for secure internal and external communication and the establishment of a company-internal market for time, the scarcest resource in most corporations. Revenues will include per-seat enterprise license and maintenance fees.

### Motivations

Time, creativity, opinions, experience and knowledge have real value. Nearly three billion people communicate on social networks today. These networks encourage sharing of these valuable assets and glean information about users' lives for free. “Free sharing” has virtually become the prevalent meaning of the word “social” in the term social network.

Social networks offer a great platform for people to communicate, initiate and maintain social relations and interactions free of charge. But it comes at the price of giving away personal information for free, and many users increasingly feel uncomfortable doing so. An expanding base of users would prefer to pay for verifiable security and guaranteed privacy.

Additionally, most users are also providers or potential providers. They have the knowledge and creativity to provide valuable services and content, or could provide such services and content if they were compensated for it. Unfortunately, they currently lack a way to establish relationships with the potential consumers of their services that allows them to be adequately compensated.

A few large Internet entities are taking advantage of their users' ill-informed generosity by luring them into the belief that they should freely share all of their personal information, likes, dislikes, friends and even expertise in exchange for a prosthetic enhancement of their social life. They are being exploited and see no financial compensation for what they share while the providers of these platforms are monetizing their lives.

Zeitmarket is a platform for discerningly sharing valuable services and content in a private, secure manner and being compensated for their value. Anything valuable that is shared becomes part of a global marketplace in which demand for services and content drives the price of provider's time higher and higher. It is all secure, private and non-exploitable, and as its perceived value goes up, so does provider compensation.

### Realizing the Value of One's Time

People today conduct business and share information privately through interactions with networked devices. While traditional communication channels like telephone, television and print have well-established means of exchanging rendered services for money (e.g., 1-900 numbers and pay-per-view or subscription models), the Internet has seen only partial attempts at creating a means for everyone to monetize their time online.

Zeitmarket aims to establish a platform for buying and selling time online by deploying an online marketplace with the following central elements:
Users participate in privacy-protected social and commercial conversations through a cloud-based mobile or desktop app.
The focus is on secure text messages for initial contacts and secure video/voice calls for real-time communication.
Users may hide their identities from other users behind admittedly pseudonymous “persona” names. For example, a crime victim may use a pseudonym to ask a social worker or lawyer for advice.
If advertisers want Zeitmarket users to spend time engaging with their ads, they must pay those users the value of their time for what are essentially ad-hoc focus group studies.
The buyers of time pay service fees charged by the sellers of time. Service fees are capped using a novel price-limiting algorithm that determines the value of the communication fairly.
Zeitmarket charges the providers of time a small percentage of their revenues.

### Fostering Provider/Client Relationships

Zeitmarket adds an online dimension to existing client-provider relationships that require secure and private communications. For example, a lawyer could invite clients to engage in privileged online audio/video conversations with confidence that the content of such conversations could not be intercepted as a phone call could, nor that it is stored and analyzed by an intermediary.

Zeitmarket facilitates new client-provider relationships by matching those who provide services with those who want to consume such services online.

### Protecting Privacy

Recent advances in networking technology have exacerbated the problem of privacy. Threats to and breaches of privacy will likely become much worse, at least in the near term.

By way of example, in Germany, concern about the need for strong encryption goes right up to the highest levels of the government. The government has also encouraged members of the German public to take steps to protect their own communication.

### Benefits

Zeitmarket is a unique commercial/social platform enabling users to realize the value of their time, while protecting consumer privacy. To attract and retain all potential buyers and sellers of time online, Zeitmarket offers a rich platform featuring:

1. Secure Internet transmission of audio, video, messages, screens and documents.

2. Membership, identity and relationship management that protects consumer privacy. Zeilmarket fully protects the privacy of its users and the security of their communications. Its privacy policy is strong, transparent, concise and legally compliant. A member may define one or more real or fictional identities called personas. Anyone who sees a fictional persona will be able to tell that it is fictional and won't see the owner's true identity unless that owner chooses to reveal it.

3. The ability for any member to offer services and collect revenues for it. Zeitmarket enables the provision and consumption of any and all imaginable services and content that can be provided online using many supported media formats, either for free or for a fee. Any Zeitmarket member can convert time to money by:

a) providing their professional time online (and offline, utilizing the Zeitmarket time measurement features) to current and newfound clients in exchange for fair market fees, either 1-to-1 or 1-to-many, including broadcasts (teaching courses, giving lectures, performing concerts or any other activity of interest to an audience of one or more clients;

b) donating their personal time online to admirers and fans in exchange for fair market fees that go to the member and/or their chosen charity;

c) participating in low-to-medium-skilled activities such as academic or corporate research studies for which they are paid fair market fees;

d) accepting text, banner and/or video ads from advertisers willing to pay them fair market fees for exposures, clicks or other proxies for time;

c) engaging in conversations (perhaps called adversation sessions) with market researchers willing to pay them for their time reacting to and opining about pitches, product ideas, announcements, etc.

A fee based on the Zeitprice of each user's current persona is levied on each communication with the user by another user's persona and earned by the initial recipient of the communication if there is a verifiable sign of the sender's interest in the reply of the initial recipient such as a reply to the reply, an agreement to engage in a paid conversation, or the designation of the sender as a friend on Zeitmarket. As explained in 3(b) above, a celebrity may specify a charity approved by MINE to which initial contact and/or conversation fees will go.

5. A Tiered Pricing System that Protects Consumers from Inflated Fees.

Zeitmarket enforces an upper limit on the hourly rate that a persona may charge for his or her time. This limit is referred to herein as the Zeitprice. The Zeitprice scale is chunked into thirteen tiers of exponentially increasing Zeitprices, referred to herein as Levels. Every persona at a given Level has the same Zeitprice.

Any provider can either charge an initial fee that is the standard base level within Zeitmarket for users or tentatively charge a higher fee during a period of probation. A certified professional provider can either charge an initial fee that is the standard base level within Zeitmarket for certified professional providers or show Zeitmarket their credentials and evidence that a higher fee that they already charge meets fair market standards. The initial fee determines the initial Level.

The sum of the time all personas of a particular user can charge for is capped at a maximum of 100 hours per week.

Once a provider of time has worked long enough on Zeitmarket, an algorithm that runs periodically adjusts their Level up or down based on their Success, a function measuring how well and how fast a provider fills more time slots with higher-paying customers.

The so-called Price Range of a given Level is bounded by the Zeitprice of that Level and the Zeitprice of the Level below ($0 below Level 0). Any new provider can choose his or her initial Level and an initial published price within the corresponding Price Range, provided, however, that such Level, the associated Zeitprice and the initial published price will all be clearly marked as tentative. After one or more rounds of observation and adjustment by the Universal Zeitmachine, the provider's Zeitprice will be declared established at a Level where his or her observed Success is not below a required floor. Such Level may turn out to be the lowest possible Level. The established Zeitprice will be published and can only be changed subsequently by the Universal Zeitmachine.

The population of personas at each Level is expected to fit a pyramidal distribution. The higher the Level:
the smaller the population at that Level;
the more plentiful the privileges;
the higher the Zeitprice.

6. A Provider Finder that is quick for buyers and fair to sellers. To make category browsing less intimidating to consumers, algorithms continuously optimize both the category tree and the order of search results that each searcher sees.

7. A Conversation Scheduler that works with the calendar of choice. Zeitmarket shows conversation conflicts it finds in the user's preferred calendar and enters conversation appointments and reminders in that calendar for you (API-permitting).

### Personas and Privacy

Secure communication is a trademark characteristic of Zeitmarket.

A consumer's privacy is protected unless he or she has waived it. Consequently:
A real or fictional identity is represented by a persona that the member has created.
No persona is listed in any directory unless its owner chooses to make it visible either to everyone or to specifically designated members, including members qualified due to the nonrefundable pre-payment of an amount matching the Zeitprice of the persona at issue.
Each member has the option in each invitation or conversation to choose any persona they own to represent them.
A member who can see another member's pseudonymous identity in a conversation, contact list, invitation, etc., will see that it is fictional but will not see the owner's true identity. Only the owner can enable another member's ability to see their true identity.

Certified professional providers selling services may not do so anonymously. Uncertified providers and normal members providing services may do so anonymously.

Normally, when a provider uses multiple personas, their purpose is to provide multiple services. Consequently, each provider's persona (not each member) is considered a unique provider.

### Zeitprice

The upper limit price that each provider can charge consumers is called their Zeitprice. The provider may choose to charge the full Zeitprice to every consumer, to charge a discounted price to every consumer, or to negotiate a discount with each consumer individually.

Zeitmarket publishes each provider's current Zcitprice and clearly indicates whether it is tentative or established. A provider who provides more than one service should use a different persona, a different Zeitprice, and a different discounted price for each service.

The Zeitprice algorithm uses a performance-based formula based on measured Success, not on manipulatable and biased public feedback. It does not use privacy-violating analysis of the content of communications and of the services provided.

### Applications

Two key applications of Zeitmarket are:

1. Real-Time Private Conversation between members individually and in groups:

Any group of members who have specified each other as friends can communicate securely and (optionally) anonymously via text, images, documents, voice and live video. Zeitmarket permits a large but limited number of hours per month of free video communication among friends. All other communication services for communicating among friends are offered without restrictions limiting their use.

2. Fee-Based Services rendered by members to members:

Any member can provide fee-based services to one or more simultaneous clients via Real-Time Private Conversation.

Zeitmarket helps potential clients find service providers, providing the ability to read their blogs and view other communications media before buying their services using actual currency in exchange for their time, knowledge, or services.

Zeitmarket algorithmically establishes the Zeitprice of each provider, which is the maximum price per time unit that he or she can charge for real-time communication with clients, and for services performed offline with the consent of the consumer if the provider is utilizing the Zeitmarket time measurement features. Written communication is assumed to consume a fraction of that time unit and hence will cost only a prorated fraction of the Zeitprice. If the receiver is on the same Level as the sender, their expenses for exchanging messages balance, and both effectively pay only the applicable commission to Zeitmarket.

Zeitmarket collects fees from clients and pays the provider his or her fees, reduced by the applicable commission rates.

Examples of such commerce in time include the following:

a) Professional service providers such as accountants, consultants, lawyers, physicians, tutors and investment advisors communicate with existing and potential clients. Clients can remain anonymous if they so choose but qualified professional providers will typically and may legally have to choose to be public and authenticated.

b) Musicians, artists, actors, Internet content contributors and other content creators provide live performances in a one-to-one or one-to-many fashion for a fee which is collectively paid up-front by the students, listeners (participants). The fee paid by an individual participant is at the discretion of the provider. The minimum fee which must be paid by an individual participant amounts to the provider's Zeitprice divided by the total number of subscribed participants. The maximum permissible fee to be paid by each individual participant amounts to the Zeitprice of the provider.

c) University professors and lecturers, scholars, and other professionals provide live lectures and online courses in a one-to-many fashion for a fee which is collectively paid up-front by the students/listeners (participants). The fee paid by an individual participant is at the discretion of the provider. The minimum fee which must be paid by an individual participant amounts to the provider's Zeitprice divided by the total number of subscribed participants. The maximum permissible fee to be paid by each individual participant amounts to the Zeitprice of the provider.

d) Market research and online focus-groups. Consumers sell their attention to advertisers willing to pay to win prospective customers. Consumers can remain anonymous if they so choose but qualified advertisers may not.

e) Communication between members who are not (yet) friends such as headhunters contacting candidates for recruitment or members initiating a conversation with other members of interest to them.

f) Providers such as software developers, chauffeurs, baby-sitters, utilizing the Zeitmarket time measurement features, either offline or online, work for time-based compensation.

g) GlassWalking (wearing Google Glasses or other HMDs that transmit secure video to the customer).

h) Secure publication of blogs and videos.

### Commercial Advertising:

### Message-Based Advertising

Zeitmarket does not directly sell or display 3rd party advertisements, but all visible participants who have opted in to this unique program can be targeted by message-based advertising (text, audio or video), provided the advertiser is willing to pay the fees associated with the communication, the price of which is determined by the Zeitprice of each individual receiver. Of special interest are those who are verified participants appearing—at their sole discretion—with their true identity.

The receiver of an advertising message earns the fee that the advertiser pays Zeitmarket, reduced by the commission charged by Zeitmarket, but only if the receiver clicks on a link in the message in a verifiable way, or sends the advertiser a reply to which the advertiser replies. If the receiver is in the same Level as the advertiser, their expenses for exchanging messages balance and both effectively pay only the applicable commission to Zeitmarket. If the receiver is in a higher Level than the sender, there is a net gain for the receiver. Companies advertising on Zeitmarket will typically waive the cost of text-message-based communications to them in response to their advertising messages.

### Adversation Sessions

Zeitmarket offers an alternative to text-message-based advertising called adversation. An adversation session is typically a video conversation between an advertiser and a consumer in which the advertiser pays the consumer to offer and discuss her reactions to a campaign, a product, a TV ad, a search results ad, etc. Adversations provide a new modality for advertisers to conduct market research on the Internet.

### The Social Aspect:

### Social Platform

Zeitmarket provides a platform and mechanisms for creating and maintaining private and public, personal and professional social networks. Zeitmarket members establish and maintain personal contacts with other participating members in either a personal function or to provide or obtain professional services, depending on mutual interests and/or corresponding service offerings, particularly with members outside of the user's personal circles.

### Charitable Donations

It is contemplated that Zeitmarket Providers and other sellers of time on Zeitmarket may donate their proceeds to an approved and registered charitable institution. It is also contemplated that the Zeitmarket management entity may donate its share of the proceeds, i.e., the commission, to the same or other charitable institutions.

It is also contemplated that the Zeitmarket management entity may identify international charities that have been initiated by a VIP (Entertainment, Fashion, Business, Politics, Science, etc. of national as well international recognition) or which have a strong involvement by a VIP. The VIPs may donate one or several conversations, lectures, or concerts in Zeimarket benefiting their preferred charity.

It is also contemplated that other organizations may apply for registration to also be a recipient for donations. To benefit most, they may engage in a process to become an active “VIP conversation and event organizer.” It will be useful to educate charitable organizations about the process and empower them to promote their Zeitmarket event through social and general media on their own. Giving non-profits these tools, the VIPs, charitable organizations and Zeitmarket will greatly benefit from the generated interest.

### Technical Elements

It is the combination of industrial-strength privacy and security along with high service quality that make Zeitmarket's real-time communication functions stand out when compared to services like Skype or FaceTime. Technical elements include:
Zeitmarket secure user database and directory
Communication apps with strong end-to-end encryption (platform dependent) for text messaging and high-quality video (later to be augmented by a premium mode for virtual 3D telepresence)
Integrated encryption/privacy infrastructure (best-in-class, utilizing public/private key scheme, one-way transformations, key vaults, . . . )
Server (cloud) infrastructure for establishing and optimizing connections
Social platform interfaces (depending on the platform: Facebook-plugin, iPhone/Android-App, Twitter-API)
Billing interfaces

Application Architecture

The Zeitmarket Application is divided into three major logical layers:

Main Application and User Experience
Social, Communication, Persona, Scheduling, Payment.
Cross Platform and Multi-Device Application.

Zeitmarket Services
Software services for secure identity.
Software services for secure communication.
Software services for secure storage.
Software services for scheduling (time management).
Software services for provider pricing (Zeitprice, UZM, etc.).

Zeitmarket Infrastructure
Real-time feedback on business and operations data (BI).
Secure financial transactions.
Flexible and scalable system architecture.

### Platform Architecture

To better support and maintain the Zeitmarket Application's logical layers, an exemplary implementation is constructed on top of the Zeitmarket/Private Internet Platform (Z-Platform), which is discussed in detail herein, and in commonly owned International Pat. App. PCT/US18/32149 filed May 10, 2018 (Attorney Dkt. MNE-116-PCT) incorporated by reference herein. Utilizing the services of this platform, the Zeitmarket application developers can focus on specific value offerings of the Zeitmarket Application while leaving more general software development tasks (such as user/device management, communication channel management, and the like) to a Platform Development Team. In an exemplary practice or implementation, the Platform Development Team would be in charge of research and development (R&D) efforts and maintenance tasks relating to various platform features, thus enabling a clear separation of responsibilities with respect to the platform.

### Z-Platform Components

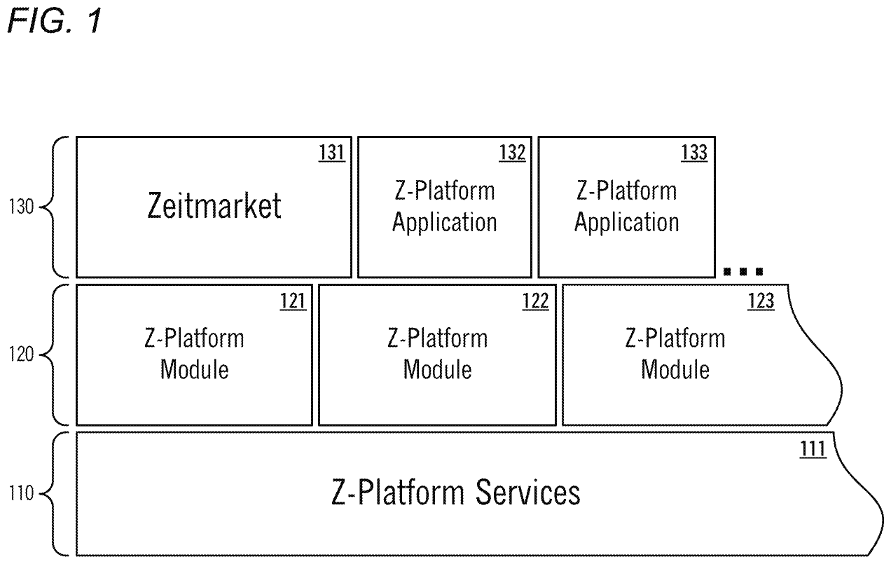

FIG. 1 is a diagram of the components of the Z-Platform 100.

The Z-Platform (ZP) Ecosystem consists of three major component groups; a services group 110, comprising the ZP Services 111; a modules group 120, comprising a collection of ZP Modules 121, 122, 123, etc.; and an apps group 130, comprising a collection of ZP Applications 131, 132, 133, etc., amongst which the first app is the Zeitmarket Application 131. Any ZP Module 121, 122, 123, etc, can utilize any combination of ZP Services 110 while any ZP Application 131, 132, 133 can pick and choose from items in both the modules group 120 and the services group 110.

### Z-Platform Services

The ZP Services component group 110 provides a variety of access functions to user, device, and endpoint management, including the following:
ZPDNS Service.
Device Management Services.
User and Persona (sub-user) Management Services.
ZP Security Services and Identity Translation Services (ITS).
Unified Message Delivery System.

### Z-Platform Modules

The ZP Modules in the modules group 120 are essentially logical units of services (with both back-end and front-end components) which are not considered part of core platform services, but can provide valuable services to ZP applications. These include the following:
Zeitlocker Services.
Payment Connector Services.
Audio/Visual Communication Services.
Platform Service Management Services.

### Z-Platform Applications

The applications group 130 includes the following:
Goal and Market Specific Applications 132, 133, etc., utilizing the platform provided modules and services.
Zeitmarket 131, as the first application, is built on top of these platform services and modules.

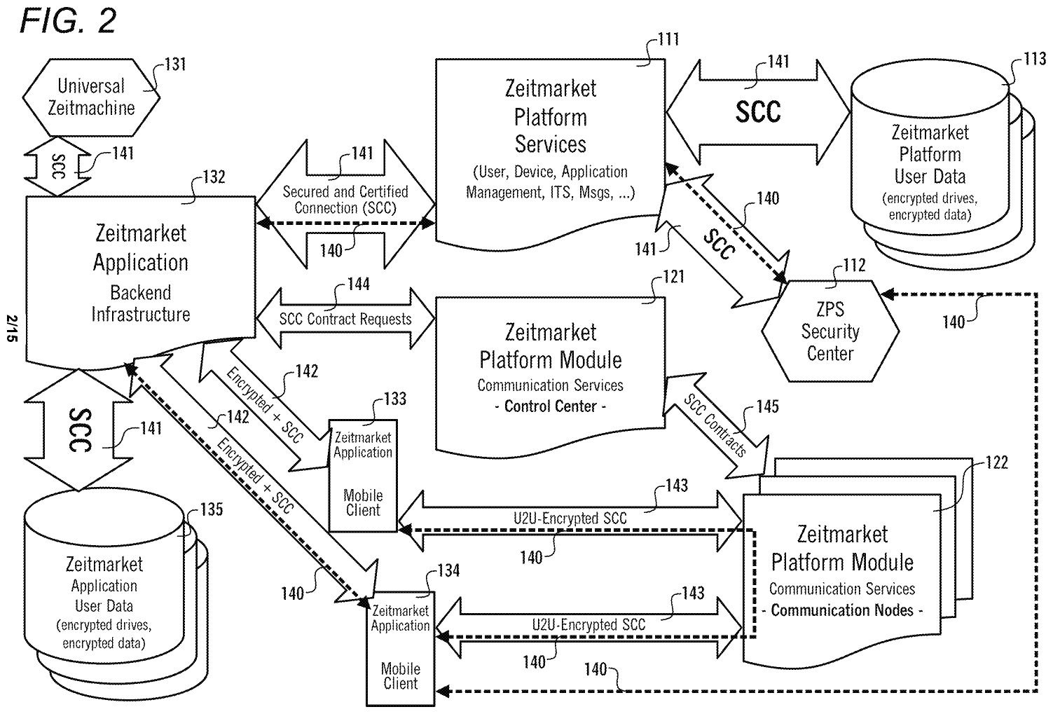

FIG. 2 is a diagram showing an exemplary integration of the Zeitmarket module with the Platform Ecosystem.

The components of the Z-Platform include the following:

Z-Platform Core Services (“ZP Core Services”) (layer 110):
Z-Platform Services 111;
ZPS Security Center 112; and
Z-Platform User Data 113;

Z-Platform Modules (“ZP-Modules”) (layer 120):
Z-Platform Modules, Communication Services, Control Center 121; and
Z-Platform Module, Communication Services, Communication Nodes 122;

Z-Platform Applications (“ZP-Applications”) (layer 130):
Universal Zeitmachine 131;
Z-Platform Application Backend Infrastructure 132;
Z-Platform Application, Mobile Clients 133, 134;
Z-Platform Application User Data 135.

As further shown in FIG. 2, the following types of connections are used between the various system components:
connections 140, which may include conventional communications connections;
secured and certified connection (SCC) 141;
connection combining encryption and SCC 142;
U₂U-encrypted SCC 143;
SCC contract requests 144; and
SCC contracts 145.

### Z-Platform Services

The ZP Services component group 110 provides a variety of access functions to user, device, and endpoint management.

The provided ZPDNS service culls static access attempts while performing built-in application-specific redirections and access token verification services.

When a newly developed Z-Platform Application is ready to join the Z-Platform Ecosystem, it gets registered (after verification and certification) with the platform services which then provide application access authorizations for both the registered endpoints and the general platform services.

The ZP Services also provide device management functions, including but not limited to device registration (utilizing a one-way ID transformation), authentication, assignments (both user and application), and usage restrictions. When a device first gets registered, it only has access to a limited set of platform services to enable the user (or the system) to execute proper access assignments (certain devices may or may not have access to applications and/or users).

Similar to the device management, the ZP Services also provide user and persona (sub-user) management, which include but not limited to identification transformations (application specific identity transformation, internal-external representation transformations), device associations, and valet services via secure boxes.

ZP security functions include but are not limited to user access verification, application access verification, key management, multi-channel encryption (utilizing both industry standard approaches and specialized content transformation services with rotating parameters), identity translation services (ITS: per-app user ID) and security primitive services such as HMAC, HASH and encryption primitives.

The Unified Message Delivery System provides a guaranteed application aware message delivery to the ZP user/persona inboxes. When applications access platform user information services, they are sent the “envelopes” which are addressed to the user within the application domain. This infrastructure is also used to accommodate inter-application communications for a given user without compromising his/her identity. The messaging system can also be configured to introduce random latency to the delivery schedule to avoid delivery time specific information leakage.

### Z-Platform Modules

The ZP Modules are essentially logical units of services (with both back-end and front-end components) which are not considered to be part of the core platform services, but can provide valuable services to ZP applications. These “services” are still hosted within the ZP Infrastructure and have internal secure access to the core ZP Services while observing the ITS requirements. In the current version, there are four modules in the ZP Ecosystem.

Zeitlocker is Z-Platform's secure off-site/on-site storage solution. The lockers are identified by reference identifiers (textual representation) and are opened/closed with pass-phrases (user assigned text, bitmap, sound, etc.) and PINs (system assigned). The actual location of a locker is generated from all 3 information sources through the combination of one-way transformations. The associated symmetric encryption key (currently at 512 bit) is also derived utilizing all 3 information sources, thus both finding the location and acquiring the decryption key requires proper access to all the different domain sources.

The Payment Connector Services connect ZP's internal accounting services with third party payment gateway services.

The Audio/Visual Communication Services module provides a fully featured communication service to the integrating applications. AN sessions are handled as contracts with negotiated communication nodes and control mechanisms. Two or more users can be connected in an audio/video session, which includes adaptive bandwidth transmissions, geo-aware routing and bridged connections with all these having the ability to optimize not only for fastest delivery, but to increase routing complexity (to interfere with tracking). On top of the prioritized audio and visual channels, a custom channel is also provided, which enables file/document sharing, shared desktops and shared gestures.

The stages and states of the communication sessions are closely observed and tracked (but not the content!) in order to provide immediate conflict resolution and/or contract renegotiations in case of quality problems. This feature is also essential in providing prioritized sessions to paying/free services.

All communications are encrypted with session keys, which the participants ncgotiate after successful initial connections (which were encrypted with system provided communication keys). This ensures that the Z-Platform Services have absolutely no access to the content of the communication. The session keys can be rotated and renegotiated on-the-fly, out-of-band as well, further strengthening the platform security services.

The Platform Service Management module is responsible for handling device, user and application access associations. This includes granting and revoking access to different actors to/from different services and is responsible for renewing/renegotiating certificates and providing basic key management services.

### Zeitmarket Product

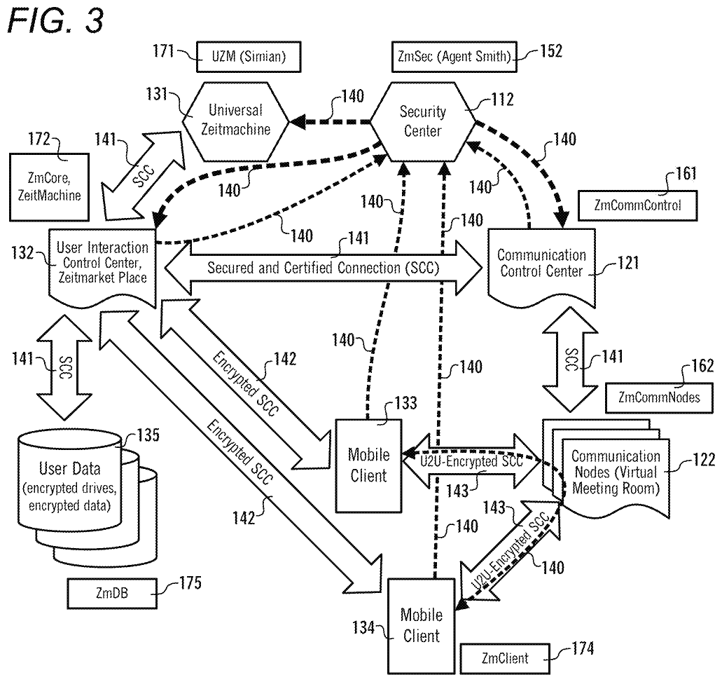

FIG. 3 is a diagram illustrating the operation of various components of the platform 100 shown in FIGS. 1 and 2 and their associated software modules:

| Component | Module |
|---|---|
| Security Center 112 | ZmSec 152 |
| Communication Control | ZmComm Control 161 |
| Center 121 | |
| Communication Nodes 122 | ZmComm Nodes 162 |
| Universal Zeitmachine 131 | UZM 171 |
| User Interaction Control | ZmCore, Zeitmachine |
| Center 132 | 172 |
| Mobile Client 133 and 134 | ZmClient 174 |
| User Data 135 | ZmCommNodes 175 |

The operation of these components is described below, in the following contexts:
Applications/User Experience;
User Interaction Control Center;
Universal Zeitmachine and Zeitpricc;
Security;
Communication Services;
Zeitmarket Infrastructure; and
Server/Cloud Infrastructure for Telecommunication.

For simplification purposes, Z-Platform components are not marked separately in FIGS. 3-10.

### Applications/User Experience

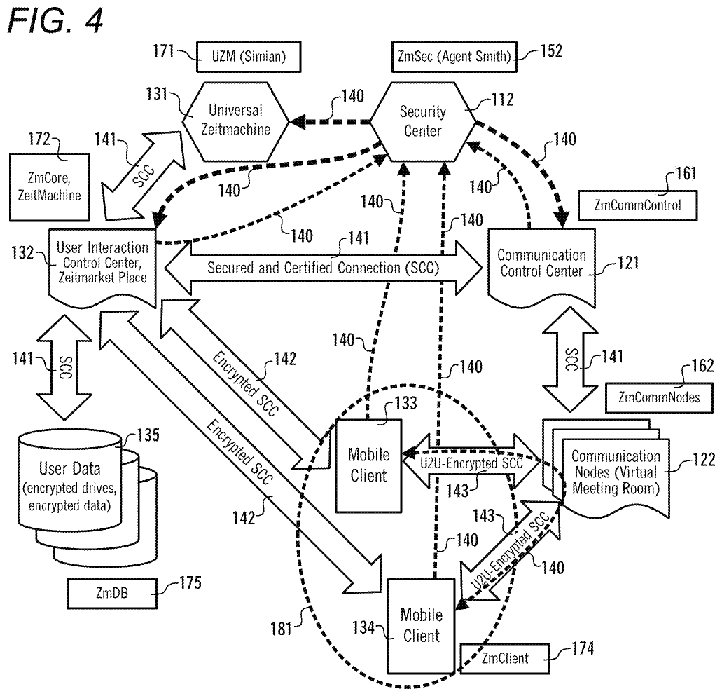

FIG. 4 is a diagram of the Applications and User Experience components 181 of the Zeitmarket Product. These components comprising Mobile Clients 133 and 134 and the ZmClient module 173.

As shown in FIG. 4, the Mobile Clients 133 and 134 communicate with each other and with Security Center 112 over connections 140. The Mobile Clients then use security-related data obtained from Security Center 112 to create a Secured and Certified Connection (SCC) 142 with the User Interaction Control Center 132, and to create a U2U-encrypted SCC 143 with Communications Nodes 122 in a Virtual Meeting Room.

Users access Zeitmarket services through mobile client apps that run Zeitmarket client software. Zeitmarket client software will run on:
Phones (iOS, Android, Windows)
Tablets (iOS, Android, Windows)
PCs (Mac OS, Windows, Chrome, Linux)

Zeitmarket utilizes “native” applications to ensure high performance and best possible utilization of specific device features. A careful balance is struck so that the user experience is consistent with other applications on that platform as well as that of the Zeitmarket app itself on other platforms.

Support is provided for emerging platforms and peripherals, such as wearable computing, an emerging area with significant relevance to Zeitmarket. Google Glass and similar wearable video recording and display devices are a natural fit for video conferencing and potentially other services that would benefit from telepresence.

### User Experience Goals

In an exemplary embodiment, the Zeitmarket app user interface strives for simplicity. When possible, a “less is more” approach is taken toward the development of features.

In an exemplary embodiment, the contents and layouts of most screens in a Zeitmarket app depend on the host OS, the means of pointing and the size of the device's display. Devices with smaller displays show fewer simultaneous UI elements.

### Home Screen

In an exemplary embodiment, the Home Screen is clean and sparse, except for frequently-used graphical user interface elements that a user has chosen to appear upon login. In an exemplary embodiment, there are never more UI elements visible on the screen than absolutely needed at any time. The home screen components of a desktop Zeitmarket client may include the following (mobile clients may display less):
Links to access Account Settings and Help and Support
Search bar with links to advanced search options and the persona directory browser
Timeline calendar/Communication log
Text message view
Identity bar indicating the persona the user has selected to represent him or her.
The collection of personas belonging to other users that this user has contacted while assuming the current persona identity (displayed in the identity bar)—i.e., the context container.
The collection of personas owned by the user—A visual indicator appears when a message or call is being received by a particular persona and gives the user the option to answer the call.
A “marketing strip or banner” that displays featured personas to aid the user in discovering services offered by other users, promote Zeitmarket events and disseminate Zeitmarket related news. The user has the option to hide this.

### Help and Support Screens

The help and support section provides users with resources and documentation describing the Zeitmarket system and its usage, including:
FAQ
Support contact information—including a customer support persona as well as traditional email/phone.
Topic-based user documentation for Zeitmarket features
Training video and related materials, including strategies for marketing and promoting a user's personas within Zeitmarket.

### Accounts:

### Users, Members and Subscribers

A person who wants to use any feature of Zeitmarket other than read-only searches of the persona/provider directory must create an account and specify at least one payment method (credit card, Apple Pay, PayPal, etc.) for identity verification purposes. While all these features utilize the ZP Services, it is transparent for the users.

In this document, a user without an account is called a visitor. A user who has registered an account is called a member. A member who pays a recurring subscription fee (which may be zero) is called a subscriber. Subject to the introduction of subscription fees, a member who is not a subscriber is either a “tryer” (if participating in a full-function time-bounded free trial) or a visitor.

What Zeitmarket knows about each member's true identity is (a) the real name on the payment account that the member used most recently to transact financially with Zeitmarket and (b) other identifying information that the member has voluntarily provided to Zeitmarket. The “other identifying information” in a user's identity may include such attributes as gender, age, relationship status, geographic location, occupation, hobbies, professional licenses, education, work history, social network handles, etc. With such optionally provided information, Zeitmarket can do a better job of matching providers and consumers, certifying the initial Zeitprice, recognizing friends eligible for free videoconferences, etc.

### Privacy Assurances

Each item of identifying information in the member database is marked by Zeitmarket as either verified or unverified.

Subject to exceptions required by law or explicit and active consent by the member, Zeitmarket never discloses member information (verified or not) to advertisers or other entities inside or outside Zeitmarket. Zeitmarket collects such information to enable users to log in, pay, be paid, receive reminders, see relevant search results, display bona fide credentials to clients, and other actions that members joined Zeitmarkct to perform.

### Account Creation

To register as a member, a visitor must provide:
A unique user name for use by the member and Zeitmarket use as account identification.
A user-chosen password of sufficient strength.
One or more pieces of contact info, e.g., email address, text-capable phone number, social network ID, Skype handle, etc.
One or more financial account ID's (PayPal, bank account, debit card, credit card, Apple Pay, etc.) and the accountholder name on each.
The company will debit a designated account when the member owes Zeitmarket money and will credit a designated capable account when Zeitmarket owes the member money.
Details such as which credits/debits are made on a monthly or daily schedule and which are made at the moment that fees are incurred will be decided at a later time.

### Terms of Use

The Zeitmarket Terms of Use (TOU) module is first shown to the user during registration. The user can access the latest version any time through the help and support links. The contents of this document include, but are not limited to, the following:
Statement regarding prohibition of criminal activity.
Individuals are limited to a single Zeitmarket account.
Business entities are considered separate from individuals so that a person can have a separate account for a business, provided the account is in the name of the business, not the individual. A business account is a meta-account, bundling the services of staff members in the form of their staff member business persona accounts, each under the umbrella of the employing business.
Fee schedule.

### Account Settings

The Zeitmarket client provides a means for users to specify preferences related to their account, including the following:
Credit card billing info
Email address and other contact info
Password changes/account recovery settings/multi-factor authentication preferences
Time zone—with an option to update automatically based on information from the device running the client. Zeitmarket uses UTC internally, but displays local time dynamically in the client user interface.

Users also have access to usage information related to their account, including:
Account monetary balance, measured in the user's local currency
Account communication balance, measured in hours and minutes
Earnings report and accounting for proceeds received from other users
Overview of all personas owned by the user, their current Zeitprice and their current asking price (usually the same or lower)

Users must not create multiple user accounts (a violation of the Zeitmarket TOU).

Users are not required to provide a credit card or other form of payment to open an account, but their activity as a visitor will be limited to browsing the persona directory.

The Zeitmarket client will support multiple languages, however the language selection will likely happen before the client is installed (with the appropriate version installed based on the app store used to access it) or automatically based on the current OS.

The Zeitmarket app can be localized, but user-generated content such as messages, comments, and blog posts will appear in the language of the user that created them.

### Zeitmarket Services:

### User Interaction Control Center (ZmCore, Zeitmachine, ZmDB)

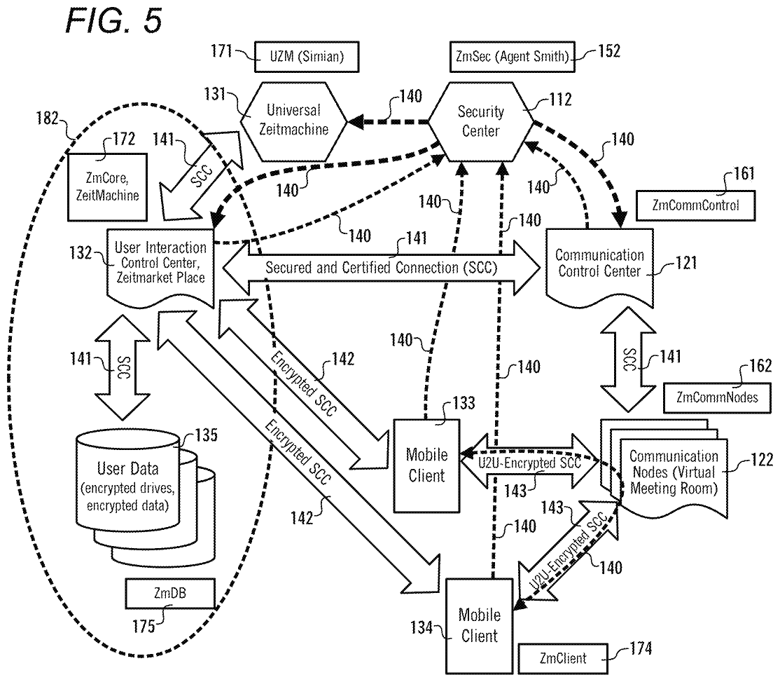

FIG. 5 is a diagram of the User Interaction Control Center components 182, which comprise the User Interaction Control Center 132, the ZmCore/ZeitMachine module 172. User Data 135. and the ZmDB module 175.

The User Interaction Control Center 132 uses connections 140 to communicate with the Security Center 112, and obtains security-related data that is then used to create respective Secured and Certified Connections (SCCs) 141 with User Data 135, with the Mobile Clients 133 and 134, and with the Universal Zeitmachine 131.

Zeitmarket is a suite of cloud-based services. The services support the creation and management of secure identity, communication, scheduling and pricing.

### Personas and Providers:

### Personas

Users of Zeitmarket interact with each other exclusively via personas. A persona represents a real user or a fictitious character. Zeitmarket strives to conceal the relationship of fictitious personas to members. Each member can choose to expose their true identity through a persona or remain anonymous. At least one persona is required to represent a Zeitmarket user, although they have the option to create any number of additional personas.

A persona name has two parts:
<short name> <disambiguating characters>

The full name of a persona P1 must be unique across the service.

The short name alone need not be unique across the service or among the member's personas. But for esthetic reasons, the short name can be displayed alone to another persona P2 whenever there is no other persona with that short name connected to P2 (and thus no ambiguity).

The disambiguating characters are suggested by Zeitmarkct, details TBD.

The short name can be the persona owner's real legal name (the name on a verified financial account or government-issued ID) or a pseudonym of their choosing. In important contexts such as search results and invitations, every persona name is badged as:
“Real Name” if verified as such or
“Fictitious Name” if so desired (no verification required) or
“Possibly Real Name” if in process of verification or
“Likely Fictitious Name” if unverifiable.

### Providers

A provider is a persona that offers a service to other personas. A provider can both sell their own time and buy other people's time in private conversations. Any user can be a provider with any of their personas.

Like any persona, a provider can choose to remain anonymous. We encourage and expect the vast majority of professional providers to identify themselves in a verifiable way to potential customers.

A certified professional provider is a persona that offers a service to other personas under his or her real name and the professional qualification of such provider has been certified by Zeitmarket.

### Profiles

Each persona has a profile with standard fields and optional elements, such as a description, a picture and a bilog. The blog allows the persona's owner to discuss topics of interest as well as describe any services that the persona offers as a provider.

### Identity Disclosure

A persona may reveal a user's true identity or provide the user with anonymity. The choice is up to the user and is revealed to viewers of the persona. A persona representing a real user will be labeled as such when viewing the persona's profile. A graphical “badge” identifies verified properties of a persona.

The verification process can produce different levels of verification—i.e., verification “strength.” One item of verification, such as a credit card, produces one verification “bar.” Two items produce two bars, and so on. Possible verification points include:
Credit Card
Facebook
LinkedIn
Other social networks or services approved by Zeitmarket
Referral by other trusted and identified members of Zeitmarket

Additionally Zeitmarket will provide a higher level of certification for celebrities and VIPs, which may involve Zeitmarket staff performing actual research. This level of certification occurs at the sole discretion of Zeitmarket.

### Service Categories

A user can create personas to provide services in different categories (e.g., music instruction and automotive repair).

A user cannot seek clients for a provider they own until that provider's persona has been tied to a specific profession by the selection of professional category keywords (e.g., “Legal, Health, Education, Entertainment”). A small number of category keywords (limited to around 20 for each persona) can be chosen from a much larger set of suggested choices and/or categories that the user invents.

A user who wants to deliver content in multiple related categories can construct a constellation of personas linked through blog comments. This allows content to be separated by topic (and individually ranked), but still linked for cross-marketing purposes.

### Provider Verification

In addition to the usual identifying information, a provider can supply Zeitmarket with professional licenses and other credentials. Providers who provide services that do not require credentials can attest to their experience and provide Zeitmarket with supporting evidence. If satisfied, Zeitmarket will place an unforgeable badge in the provider's profile with an appropriate label like “Credentials Verified” or “Experience Verified” in distinctive type. Zeitmarket can revoke the badge if the supplied information expires or is deemed to be fraudulent.

When Zeitmarket has verified the provider's qualifications, it agrees to set the provider's initial Zeitprice to their standard off-line hourly fee, or to the Zeitprice of the third Level if these fees are not known or lower than the Zeitprice on the third Level.

### Condition-Based Availability

A subscriber can adjust a setting to indicate whether an owned persona is willing to enter into a conversation when that subscriber is not already scheduled on Zeitmarket and other conditions are met.

Availability conditions in the settings of a subscriber's persona:
available anytime
available if using this device
available now
unavailable

Availability conditions in a future time slot of the subscriber's calendar:
available
available if using <device name> device
unavailable

### Zeitmarket Directory

The Zeitmarket Directory is a user view of the persona database. A search function allows users to search for user-owned personas and providers based on search term(s) that they specify. Advanced options allow users to further refine their search; for example a search option allows users to filter results to display only personas with an “available now” call status.
Sophisticated server-based data analysis.
In addition to searching, users (represented by one of their particular personas) can browse a centralized directory of public personas organized by category. When privacy settings allow it, real-time information about each persona is displayed to indicate their call status (e.g., online and accepting calls). The communication cost for the persona is also displayed.
Options to browse the Zeitmarket persona directory with sorting and filtering (by topic, Level, etc) help the user to discover other users and their services within the Zeitmarket network. Additionally, users are able to access existing contact/friend lists from email and other social networks and invite those friends to join Zeitmarket.
For part-time service providers (and/or those with irregular schedules), the persona directory browser can match them with consumers looking for their service. The search function of the persona browser can be used to search for particular categories of service at particular times. For example, students in need of help can be instantly connected with a tutor on demand. This allows qualified individuals with some free time (but possibly irregular schedules) to become tutors by connecting with in-need students in real-time.
Entries in the database ensure that a persona is only visible to certain specified personas when searching or browsing the Zeitmarket directory. The persona can specify visibility to the general public, all friends, every persona whose Level is the same or higher than theirs, an explicit list of personas or even a single anonymous persona.

### Saved Contacts List

Through directory searching, directory browsing, a Zeitmarket invitation, or a received communication using social media or email, a member may discover a persona of interest. The member may add such a persona to a list of saved contacts. There is a separate such list for each of the member's personas.

### Recent Contacts List

Whenever a member communicates with a persona, that persona is automatically added to a visible list of recently contacted personas. There is a separate such list for each of the member's personas.

### Scheduling:

### Calendar

The primary activity of a Zeitmarket user is to initiate, schedule and engage in audio/video communications between one of his or her personas and personas of one or more other users. In many cases, this requires arranging a meeting time in advance. The Zeitmarket app facilitates this by providing its own secure calendar, stored on the server. The calendar system provides tools to ensure that personas aren't double-booked, reconciling all the various appointments within all of a user's personas
The calendar provides a place for users to designate time within their schedule that is available for Zeitmarket. For some providers, a public reservation system (like those often used by hotel websites) may be appropriate, where blocks of available time are publicly visible to users. Other providers may wish for their schedule to remain private and do not want to publish it, in which case prospective clients will request an appointment time. Publicizing available time allows potential customers to search for providers available at a particular time slot.

### Calendar Settings

When persona owners block out available time, they are also able to specify a priority for the time slots to indicate which times they would prefer to be booked first. This priority is expressed by three options:
Best—The persona would prefer that these slots are booked first.
Good—The persona is basically neutral with respect to these slots.
Acceptable—The persona is available for these slots, but would prefer other slots to be chosen first.
Unavailable—Used to explicitly exclude time blocks from Zeitmarket Timeline
The calendar also functions as a timeline in the sense that it provides methods exclusively and privately to a persona's owner to access that persona's activities in Zeitmarket, including text messages and video/audio conversations, (but not any access to text/video/audio content—exclusively metadata), providing a unified log of communication within the Zeitmarket network. The timeline can be traversed both in the future and the past to enable review of everything the user has done per persona and has scheduled to do in the future.

### Universal Zeitmachine (UZM) and Zeitprice

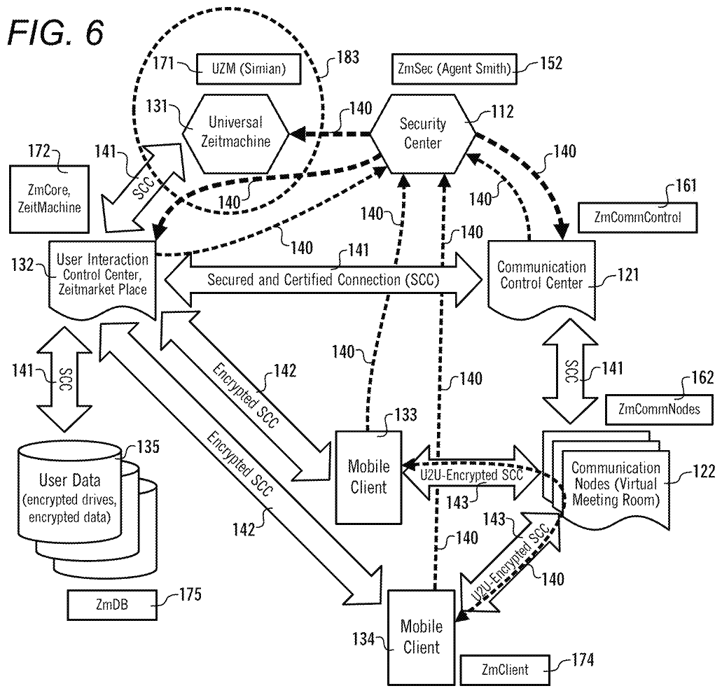

FIG. 6 is a diagram of Universal Zeitmachine and Zeitprice components 183, comprising a server-based module called the “Universal Zeitmachine” 131 and the UZM module 171, which is implemented using a Simian-based server.

The Universal Zeitmachine 131 uses a connection 140 to receive security-related data from the Security Center 112, and to use the security-related data to create a Secured and Certified Connection (SCC) 141 with the User Interaction Control Center 132.

The Zeitprice is determined by the Universal Zeitmachine 131, which implements the Zeitprice determination based on data provided by each member's individual Zeitmachine. More details on the setting of Zeitprice are described in a separate chapter.

### Security (ZMSec)

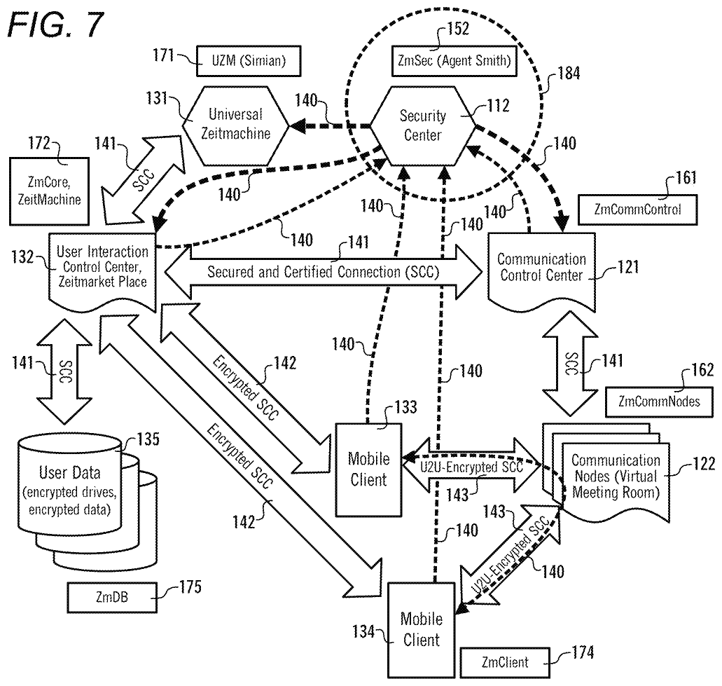

FIG. 7 is a diagram of the Security components 184, which comprise: Security Center 112 and module ZmSec 152 (“Agent Smith”).

The Security Center 112 employs an array of connections 140 to exchange security-related data with the Communication Control Center 121, the Universal Zcitmachine 131, the User Interaction Control Center 132, and Mobile Clients 133 and 134. The Security aspects of the invention include the following:

### Encryption and Privacy Features

Zeitmarket is positioned as a stronghold in personal and private communication. The underlying ZPlatform provides a level of security for the transmission of all personal data that is as high as required for protection from any form of eavesdropping and data analysis in compliance with the applicable German laws for telecommunication providers.

All network communication is encrypted.

Communication with Zeitmarket infrastructure is implemented through SSL/TLS with a certificate hierarchy in place (not necessarily rooted at a public certificate provider).

Communication with other users is implemented with a public/private key scheme, where the keying material never leaves the user's device. A key vault for recovering key material is provided.

The user has complete control over the personal information displayed by their persona(s). The user can choose a fictional name for each persona or choose to use their real name. No information will be taken from the user's account settings and exposed by the persona without the user's explicit consent.

In general Zeitmarket treats all of a user's information as private by default.

It is worth noting the different aspects of persona privacy, which are sometimes prone to conflation:

1. Listed, visible and accessible in the Zeitmarket directory—The owner of a persona can tell Zeitmarket to include it in the directory (“Listed persona”) or not (“Unlisted persona”). An unlisted persona cannot be viewed or interacted with (e.g., send a message or request a meeting) unless the persona owner grants specific permission. An unlisted persona is effectively cloaked and is not visible or accessible to a non-approved persona by any means. New personas are unlisted by default.

2. Anonymity—an anonymous persona does not reveal the actual user. Anonymity is independent of visibility and accessibility. A cloaked persona may reveal the user (perhaps the reason it is cloaked) or not (anonymous users discussing private topics). New personas are anonymous by default, but a verified persona cannot be anonymous.

An unlisted persona is only visible to other personas that have been specifically designated by the unlisted persona owner. It is never possible for a third party to expose an unlisted persona to another user in Zeitmarket without the owner's consent.

The owner of a persona (listed or unlisted) can choose to permit or block visibility to other personas who they specifically designate or to all personas in a specified range of Zeitprice Levels below and up to the Zeitprice Level of his or her respective persona. A blocking persona appears to be both unlisted and cloaked to the blocked persona.

Visibility of a persona in a higher Level can be enabled for a lower rank persona wishing to see the higher-Level persona by obtaining enough non-refundable credit in advance to purchase at least one hour of services or video communication with the higher-Level persona.

The Zeitmarket UI facilitates references to personas by providing a UI widget, such as a capsule, that displays the persona name and links to the persona profile. These references can be embedded in messages, persona blogs, etc., but references to unlisted personas are only visible to those personas designated by the unlisted persona owner. To a non-privileged persona, the capsule of an unlisted persona is blank (or labeled “unlisted” or equivalent).

### Communication Services (ZmComm, ZmCommControl, ZmCommNodes)

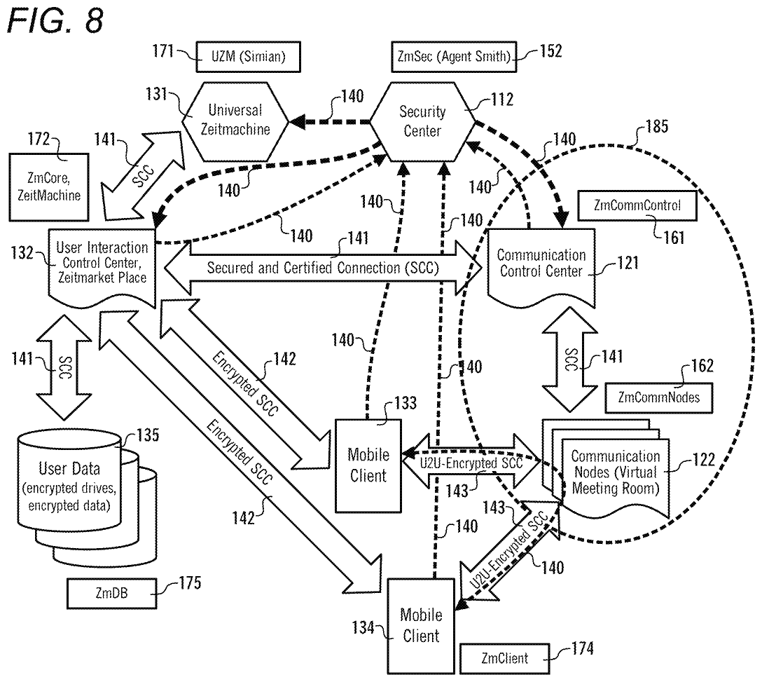

FIG. 8 is a diagram illustrating the Communication Services components 185, comprising Communication Control Center 121 and Communication Nodes 122, and modules ZmCommControl 161 and ZmCommNodes 162.

The Communication Control Center 121 employs connections 140 to exchange security-related data with the Security Center 112. The security-related data is then used by the Communication Control Center to provide respective Secured and Certified Connections (SCCs) 141 to the Communication Nodes 122 and to the User Interaction Control Center 132.

The Zeitmarket communications infrastructure utilizes the Zeitmarket Platform Communication Modules 185 and integrates the following features in the best possible manner for each hardware platform:
Communication encryption/privacy settings
Billing details
Personal contact list
Text-based conversation and its history
High-quality audio and video chat and broadcast
Document sharing

While the primary focus of Zeitmarket is interactive video chat, there are additional tools and communication media that complement it:
Shared white board
Auxiliary interactive graphics such as charts, graphs, including interactive 3D graphics.
The ability to share the user's screen, or window of another application.
Real-time text-based chat
Check-in and check-out time-stamp mechanisms to measure and quantify off-line activities performed as a service by a provider.

For example, a user who has created a persona who offers a consulting service might conduct a video training session in which they utilize a white board to illustrate their points and an interactive/animated 3D model to display complex spatial relationships.

### Communication Quality

Zeitmarket requires that the user has access to a network connection of suitable quality to support Zeitmarket services, although this is not always under the control of the user. In some cases the quality of a connection may change over time (e.g., a temporary degradation due to high network traffic). A connection that appears to be working may at some point during the conversation degrade to the point where it can no longer support audio or video for a period of time.

The Zeitmarket client informs the user of the status of the network when relevant. For example, if it is unable to maintain the current services it is providing to the user.

The Zeitmarket client will endeavor never to drop a connection. Zeitmarket assumes that unless a communication partner explicitly ends a call, the call should remain logically connected. If the network connection is lost, Zeitmarket will attempt to reconnect the user or restart the call when the network connection is restored. If the network connection is lost for a certain period of time, the user will be prompted before an active audio/video stream is reopened.

When a network connection is lost, the Zeitmarket client that was dropped will inform the user (via audio in the case of a voice-only call). Other participants on the call will also be informed that a member was lost. In the case of a voice-only call this is critical because there is no other way for the user to know they were dropped and may continue speaking as if they are still addressing other members in the call.

During a video conversation:
Best video/sound quality is achieved with respect to the available network infrastructure. Quality feedback is used to optimize the data rate. Images of participants who are currently speaking are updated at higher frame rates than images of listeners.
Video/sound is provided in any imaginable networking infrastructure (NAT, proxy, 3G/4G, WiFi).
The actual video/sound transmission is to be hidden as well as possible from network providers to allow for communication in restricted environments (VPN).
Network communication inside the VPN follows well-proven industry standards (e.g. SIP).

### Privacy Assurances

All network traffic is strongly point-to-point encrypted.

Care is taken that no private information (i.e. call logs or similar) is stored for longer than absolutely necessary to provide an adequate amount of time for customers to review their invoices, for the company to comply with applicable law, and for other unavoidable reasons that may arise.

Under no circumstances is the content of a real-time communication between users stored in any way by Zeitmarket.

Text messages are stored in a format encrypted with keys held only by the sender and recipient (and not Zeitmarket). Text messages are stored for the minimum amount of time possible (until retrieved or deleted by the client).

The optional advanced routing feature (utilizing several communication nodes) enables a high level of protection of transmission routing on top of the already provided strong content encryption. The choice of communication routing in this special case is influenced by not only finding the fastest route, but minimizing connection-pattern based information leakage and behavioral analysis.

### Communications:

### Video Conference

At least one view displays incoming video, and an optional smaller view shows the outgoing video. In the case of multi-user (>2 users) conferences, lectures, or performances such as concerts, additional views are provided for each of the participants. The user has the ability to customize the video view layout to suit their needs/preferences, dependent on the capabilities and form factor of the device.

Automatic face-tracking and attendee cropping maximizes the number of tiled user windows for the scale of the device used.

### Text Message

The user is able to read and compose text-based messages. Views and controls are available to:
browse incoming messages
compose responses as well as new messages
delete messages
attach an image or PDF to a text message.
search through messages
Standard messaging commands (e.g., Read, Reply, Forward, Delete, Compose, Edit, Attach, Send, etc.—although not necessarily with those names) are provided to allow users to manage their text messages.
The text message view displays messages sent to or from the user's currently-selected persona, and the label for that persona is displayed in the identity bar. The user can browse a list of message threads and expand each one to reveal the message thread contents in chronological order. The Calendar/Event timeline provides a global view of all messages in chronological order.

### Zeitmarket Infrastructure

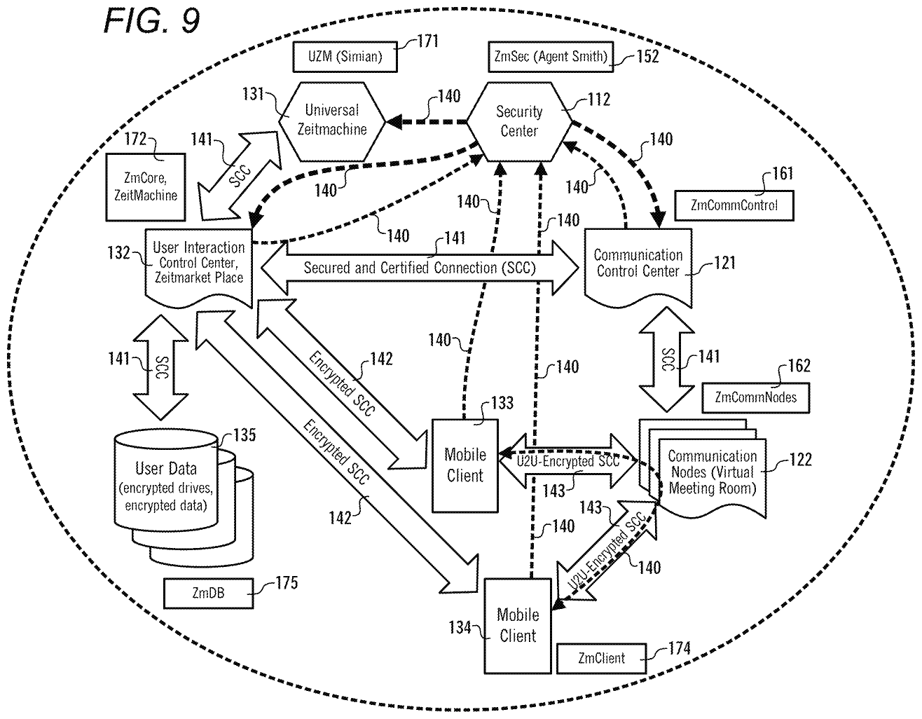

FIG. 9 is a diagram of the Zeitmarket infrastructure 186, comprising all of the components and modules shown in FIG. 3.

### Server/Cloud Infrastructure for Telecommunication.

Video chat communications are often implemented on the Internet as peer-to-peer communication, but this introduces some disadvantages:
Privacy is reduced as the communication partner can be derived on network-provider level by evaluating IP traffic.
NAT and proxy transversal is a complex real-world problem.
Latency can be better optimized between local infrastructure nodes than between any two end users.

Thus, Zeitmarket is based on a cloud-based network of infrastructure nodes that serve as a local point of connection and bundle all traffic to the corresponding node local to the communication partner, where “local” means as local as the nearest cloud infrastructure is to the respective user.

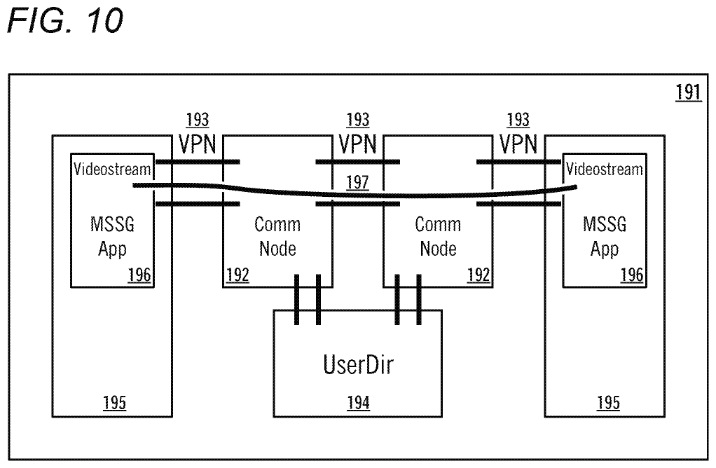

FIG. 10 is a diagram providing a schematic illustration of a server/cloud infrastructure 191 according to an aspect of the invention. Infrastructure 191 comprises a plurality of communication nodes 192 that provide respective connections into a virtual private network (VPN) 193. VPN 193 includes a local provider directory “UserDir” 194 and a plurality of remote mobile clients 195, running a suitable messaging app 196 that include videostream capability 197. The depicted infrastructure supports “virtual meeting rooms” and like functionalities.

### Zeitprice:

### Purpose

The fundamental underlying principle of Zeitmarket is that people's time has value for which they should be compensated when spent on someone else's behalf. To accomplish this, Zeitmarket provides a marketplace where an individual's time can be bought and sold. Zeitmarket continuously calculates the market price for the time of each persona called the Zeitprice. The Zeitprice is the maximum chargeable price per time unit for a particular persona.

One of the goals of the Zeitprice is to solve the trust issue of “How do consumers trust providers?” Specifically, the goal is to reduce the risk people perceive in making a purchasing decision.

As any change of the Zeitprice is based on the behavior of the users of Zeitmarket, the way it changes must be extensible, able to be simulated easily, and simple.

### Factors

The Universal Zeitmachine algorithm collects sales data (time slots offered, time slots purchased, prices paid) from the individual Zeitmachines and uses them and other factors (e.g., vacations) to calculate Success, a metric value that rises when a provider fills more time slots with higher-paying customers. Given the provider's current Level and their recent Success, the algorithm decides whether to raise or lower the provider's Level or leave it alone. On each Level, there is a Zeitprice. A new underpaid provider may ascend a Level every week and then settle into a Level for many weeks, months or years before rising further or slipping down the scale. The difficulty of caring a higher Level may be dialed up or down by management to maintain a target percentage distribution that works best for consumers. providers and Zeitmarket.

### Zeitprice Impacts

Zeitmarket considers the time of all users valuable and potentially deserving of compensation regardless of whether the user intends to offer a specific service on Zeitmarket. All types of communication within Zeitmarket, whether real-time audio/video/text communication or offline messaging, or offline work utilizing Zeitmarket's time-stamp mechanisms, incur a communication fee based on the target persona's Zeitprice. The recipient of the communication usually receives this fee (minus the applicable commission retained by Zeitmarket) to compensate him or her for his or her time.

The Zeitprice of the provider(s) in a real-time communication session defines the maximum price of an hour-long session. The price to send a text message compensates the persona for the typical time it takes for someone to read and respond to a message. That price is tied to a persona's Level and may be weighted based on the size of the message. While composing a message, the Zeitmarket client app displays real-time feedback to the user indicating the communication cost.

For example, a service-providing persona can send a message to a listed persona promoting their services, but must pay the associated communication fee. At the same time, Zeitmarket encourages meaningful responses to messages. The receiver of a message only receives revenue for reading and responding to a message if the original sender eventually replies to the receiver's first response.

The instigator of communication (e.g., the sender of a text message) usually pays the fee and the targeted receiver of the communication has the opportunity to earn revenue. A persona can start a real-time communication immediately (based on availability) or schedule an appointment. The Zeitmarket client application provides a process to schedule an appointment, which includes the ability to specify which participants are service providers (and potentially earn revenue) and which are consumers (and share the fee). The appointment negotiation process also allows the amount of the fee to be negotiated (if allowed by providers).

The Zeitprice defines the maximum fee per time unit paid by an individual consumer of services or content, but personas can offer a lower communication or content delivery rate if so desired. As noted above and if allowed by a provider, the appointment request form provides a means to request an appointment at a rate lower than the Zeitprice. The appointment is only confirmed if the provider and all participants agree to the terms. Additionally, the persona's owner can decide in advance to offer rates lower than her Zeitprice to all or a subset of Zeitmarket users, for example to an audience of viewers of a lecture, performance, or concert.

When it differs from the Zeitprice and is offered to all users equally, the price set by the persona owner is displayed as part of the persona's profile.

There exists a 100% discount list that is a non-public list of personas that are allowed to communicate without additional charge (beyond the payment of a possible Zeitmarket base membership fee). Friends are automatically added to the list.

### Initial Level and Zeitprice

A certified professional provider may set her initial Level after presenting Zeitmarkct with convincing evidence of her standard professional fee or may accept a default entry Level that is standard for Zeitmarket providers. Certification is provided by Zeitmarket for a fee payable in its entirety to Zeitmarket which is set by Zeitmarket for providers and professional providers separately. The fee is commensurate with the fee intended to be charged by the respective provider. A provider may also initially charge a temporarily higher tentative price which is visibly marked as such. A tentative price will be overridden by the Universal Zeitmachine after an initial period of evaluation. A thereby determined Zeitprice is called established. In either case, her Level and Zeitprice will increase if her Success rises. There is a natural equilibrium in what the market will pay for each provider's service, and the Zeitprice will automatically adjust to reach that equilibrium.

### Setting the Fee for a Transaction

Zeitmarket allows a provider to offer discounts to specific customers through the use of discount lists. Customers who are not on the provider's discount list may negotiate a one-time discount with the provider.

### Setting the Commission for a Transaction

Zeitmarket charges a commission for each transaction except those that solely benefit an approved charity. Commissions may vary based on the Level of the provider, the certification of the professional status of the provider, and possibly other factors.

Pricing Lower than Zeitprice

The persona owner can set the actual price charged lower than the Zcitprice of the following communication modes independently:
Real-time communication
Reading and replying to a text message
Reading and replying to an appointment request
Consuming live or recorded broadcast content

However the persona owner is not required to explicitly set these prices as they are based on the Zeitprice by default.

### Discount Lists

A persona owner can offer lower rates to select sets of personas by adding them to a non-public discount list. The discount list is a list of personas and corresponding communication rates that specify a discounted rate to interact with the persona that owns the list.

Some entries in the discount list can be set to 100% to allow friends to communicate without additional charge (with the possible exception of a Zeitmarket base membership fee). Friends are automatically added to the list at a 100% discount. Another use of the discount list is to provide loyal customers a reduced rate. For each entry the discount list can specify a fixed alternative price or a reduction from the varying Zeitprice (expressed as a percentage of the Zeitprice or a fixed discount).

### Offline Work

Sometimes an expert advisor can and should do document research or preparation or development work without the client present. Sometimes the client is present but the communication is limited to establishing the beginning and the end of a service provided offline. If there is no preexisting billing relationship between advisor and client, or if the client is interacting anonymously, they may want Zeitmarkct to bill the client for the advisor's offline time. Offline work can be charged just like online work per unit of time.

Offline work hours are not required to be entered into the calendar with their exact date and time, but they will reduce the overall available time that the service provider has available. The time spent and charged for will be deducted from the provider's total available billable time per work-week, providing an additional input to the Zcitprice algorithm.

### Maximum Time Budget

The sum of the time all personas of a particular user can charge for is capped at a maximum of 100 hours per week.

### Security and Privacy in Zeitmarket

On the security side, the focus was on producing a strong, non-obscure, cryptographically sound design and balance the latest crypto advances (AES-GCM, SHA3 and PBKDF2 with SHA3) with proven reliable solutions (AES, SHA2, HMAC, PBKDF2 with SHA2-512). The resulting design uses a proprietary combination of these techniques resulting in an increased resiliency towards known and yet-to emerging attacks. Only well-tested, industry standard security primitives (core code components) are used and the well-abstracted implementation also makes it possible to replace any open-source security related code with an approved 3rd party provider within a short period of time, if needed.

Principles of the security and privacy design for Zeitmarket include the following:

1. Provide a more mature security and data protection service than most current products on the market without relying on obscuring or hiding the methods used.

2. Have security be an integral part of the design rather than an afterthought. This is imperative to sharply reduce or entirely avoid “security holes”.

3. Simplify the user authentication experience (i.e., reduce friction) without compromising the security promise; and ensure human users do not need to remember strange passwords or memorize long numbers.

4. Allow multiple users to have the same user name without impeding operations or security. Zeitmarket uses additive auxiliary methods to identify individuals, such as passwords and devices.

5. Design data storage and access methods in a way that if a security breach occurs at a given storage location (such as a server facility), the stolen data is useless without access to other key information (at different server locations), including the user's device. This is referred to herein as “security-aware data segregation.”

6. In an exemplary embodiment, Zeitmarket as a service provider does not have the ability to decrypt the communications or the payload/content shared between its users. It is neither a wish nor a policy; it is a fact backed up by the usage of appropriate algorithms. Since Zeitmarket does not profit from “analyzing” any content, the operators of Zeitmarket do NOT read anything, not even from inside a user's phone app nor in the browser (contrary to conventional and current practices of others).

7. Zeitmarket as a service provider does have the ability to identify and associate its users and personas with real-world people with valid identifications, which has the benefits of ensuring legitimate, law-abiding operations, and to help ensure that users are paid properly; and not to impede users' activities.

8. In Zeitmarket, a given real-world user may have several personas (virtual representations). The Zeitmarket operator does have the ability to track a persons back to a user (again, so that Zeitmarket can pay its users), but cannot easily identify all the personas of a given user.

9. Within in the platform there will be no inference of who is talking to whom from observing call patterns. As there are the means in Zeitmarket to route calls to any or more of the Communication Nodes, the call routes can be randomized, making it extremely difficult to identify participants.

10. Access to phone numbers/contact lists: In an exemplary embodiment, Zeitmarket applications do not require special permissions to get to the users' contact lists or phone numbers; and there is no need for Zeitmarket to have access to phone calls. As exemplary embodiments of Zeitmarket do not store any of this sensitive information, users can be assured that no spamming or malicious mail is going to originate from them because of Zeitmarket.

To satisfy all of the above-mentioned principles, exemplary practices of the invention utilize a unique authentication and crypto-initialization approach referred to herein as “Reference and Security Box Indirection.” With its innovative access patterns, this technique is unique to the Zeitmarket Platform. Aspects of this approach are described in greater detail in commonly owned International Pat. App. PCT/US17/47430 filed Aug. 17, 2017 (Attorney Dkt. MNE-114-PCT), entitled “Multi-Factor Protected Private Key Distribution” and incorporated herein by reference.

Zeitmarket's PII (personally identifiable information) storage is segregated and distributed amongst several data stores and are assembled to coherent information in the last possible moment. The Zeitmarket Platform also features an innovative DNS approach that helps to identify and mitigate potential access risks (attacks) at an early connection phase.

As a Z-Platform Service Module, the proprietary Zeitlocker storage solution provides a brand new approach to store encrypted content in unique ways which include temporal, spatial and persona level access pattern awareness and guarantees that only those can get to the content (emphasis on getting to the content, not opening it yet) who the locker-owner deems fit. How the content is decrypted is a whole different matter and requires permission—and in some cases even real-time authorization—from the owner.

The combination of all these techniques and attributes enables a highly secure platform (ZP) which is the backbone of Zeitmarket's services.

### Customer Acquisition

Exemplary practices of the invention enable dynamic tuning of digitally-based campaigns to attract and retain a diverse membership or customer base for the platform. Marketing programs based on the platform can use promotions and incentives to maintain selected provider-to-consumer ratios and Zeitmarket Level distributions.

### Target Markets

Weak security exposes people and organizations to an array of risks. In contrast, exemplary embodiments of the Zeitmarket invention provide strong security; and as a result, any industry, profession or government agency to which communication privacy is important is a potential adopter of the Zeitmarket invention.

Initial industries and their applications could include the following:

| | |
|---|---|
| Education | Tutoring; Employee training; Secret |
| | new product sales training |
| Entertainment | Video conferences and text messages |
| | about new theatrical scripts |
| Financial | Discussions mentioning asset amounts |
| Services | |
| Healthcare | Doctor-patient dialogs (in the U.S.: |
| | HIPAA-compliant confidentiality) |
| Market | Satisfaction surveys; Consumer |
| Research | reactions to new marketing campaigns |
| Technology | Secret new product usability testing; |
| | New product rollout planning |

Initial professions and their applications could include the following:

| | |
|---|---|
| Brand Consultant | Trademark or logo testing |
| Fund Raiser | Solicitations for charities or candidates |
| Investment Advisor | See “Financial Services” above |
| Legal Counsel | Attorney-Client Privileged discussions |
| Management Coach | Confidential discussions of situations |
| Physician; Nurse | See “Healthcare” above |
| Political Operative | Campaign strategy discussions; |
| | Debate or speech coaching |
| Software Engineer | Freelance software development and |
| | testing |
| Translator | Business or government document |
| | translation |
| Usability Engineer | See “Technology” above |
| Writer; Director; | See “Entertainment” above |
| Actor | |

Zeitmarket is a simple way for a provider to be paid for their time online. Users can employ Zeitmarket for that purpose, even when privacy is not a concern. Examples include the following:

| | |
|---|---|
| Celebrity Broadcaster | Live session (concert, makeup, |
| | rehearsal, etc.) benefiting a charity |
| Renowned Scientist | Lecture to supplement income |

### Independent Worker Trend

Worldwide growth of an independent workforce is helping to create a “human cloud” of online, on-demand professionals. In the U.S. alone, there are an estimated 18 million full-time “solopreneurs” who cumulatively earn SI trillion of revenue and another 15 million part-time independents providing around 15 hours of service per week.

Zeitmarket could facilitate the growth of the independent workforce through its ability to match professionals to clients while keeping the content of their communications private. Consequently.

Zeitmarket will seek independent workers and especially their clients to become early adopters.

### Failure of Conventional Approaches

An obvious, and convention, customer acquisition strategy focuses first on growing the roster of professional providers so that the service catalog offers breadth and depth. But Google Helpouts and others who have tried this approach encountered a fatal flaw. In particular, the optimal provider-to-consumer ratio varies by profession, but is typically in the range of 1:100 rather than 100:1. Yet the latter ratio, 100:1, is the inevitable outcome of an initial focus on provider recruitment. When a service starts with 1,000 providers and no consumers, to invert the ratio it needs to attract 100,000 consumers who are ready and willing to purchase the time of providers they don't know at prices that may or may not correspond to good value. Instead, the first consumers to sign on become “spoiled” by offers of discounts and free trials. A supply glut drives hourly rates and average sales volume to zero and starves almost every provider. The ratios never invert, and the model fails.

### Zeitmarket Approach

An initial focus on consumer recruitment can keep the provider-to-consumer ratio appropriately low. Unlike Google Helpouts, the Zeitmarket invention offers benefits that can attract consumers even before professional providers join and set up shop:
In an exemplary practice of the invention, every member may be entitled to a generous amount of secure conversation with Friends without charge. Such conversations provide them free practice in the use of the Zeitmarket app and make them more comfortable and efficient when they engage in fee-based conversations.
Any member can become a non-professional provider and sell their time to other members.
Any member can sell their time to advertisers to test the latter's marketing messages.

When provider recruitment begins, the providers to court will be those who bring existing clients with them. Zeitmarket will allow them to meet with current clients privately through the Internet without having to travel to an appointment. After experiencing the benefits, some clients enrolled by, for example, their tax preparer, may promote the service to other professionals, other vendors, and to their friends. Such referrals are highly leveraged (i.e., having a multiplier >>1).

Subsequently, after several years in business, it is contemplated that many, or even most, new clients of existing providers will be a Zeitmarket member already. Membership growth will slower, and be overtaken by growth in per-member economic activity. The provider directory will be large—and better filtered, but it is contemplated that there may still be approximately 100 consumers per professional provider, rather than the other way around.

### Viral Editions

Another source of virality will be enterprises that license the corporate edition of Zeitmarket. The more employees they have who use Zeitmarket spontaneously for intra-company communications, the more likely they are to take an enterprise license. The more employees they enroll in their internal market, the more potential users of the public edition they will have trained.

### Partners to Target

Zeitmarket will expand its reach through the wide adoption by its prospective users of massive open social network ecosystems (Facebook, LinkedIn, Google+, etc.) and communications applications (Whatsapp, Messenger, Skype, etc.) as well as traditional telecommunications platforms which it strives to complement and, to some considerable degree, replace.

### Performance Monitoring

Using Zeitmarket, management can coax metrics in desirable directions through marketing promotions, thus maintaining a “virtuous cycle.” Closely watched metrics include several that are key inputs or outputs of a ten-year business plan, such as the following:
The distribution of providers and consumers across levels
Discounts from Zeitprice (by profession, by level, etc.)
Commission rates and amounts (professional vs. non-professional)
Growth rates (members, providers, professional providers)
Usage hours by medium (video, audio, text, shared docs/screens, etc.)
Ratio of providers to consumers (by profession and overall)
Profits and losses from fee and free communications.

### Acquisition Initiatives—Examples

In an exemplary embodiment, Zeitmarket management can monitor and assist early providers by assigning Levels based on their real-world fee schedules. At first, management can review Zeitmachine Level-change decisions before they take effect. Subsequently, the platform can open to self-registered providers and the Zeitmachine will be raising/lowering their Levels automatically.

### Derivative Products/Platforms:

### Editions

Zeitmarket can be operated as a unique private communication and digital transaction platform for selling and consuming time on the Web. There are, however, many derivative products/platforms that can be licensed and marketed independently from a publicly accessible Zeitmarket platform. One such derivative is referred to herein as “Zeitmarket Corporate Edition” (Zeitmarket CE).

### Zeitmarket Corporate Edition

In companies of all sizes, to get their work done, employees and contractors need other people's time. They often need to ask experts inside and outside the company for information, advice and assistance. Experts who have scarce knowledge are flooded with more requests than they can handle.

The Zeitmarket CE allows a company to set up an internal marketplace for time using Zeitmarket technology and customized business rules. Management can put their Zeitmoney (real or virtual) where their top priorities are without choking off all access to experts by medium priority project teams. A team with less Zeitmoney to spend in the marketplace would budget more carefully and weigh both a provider's Zeitprice and the relevance of their expertise as detailed in an online profile. And staff and business partners outside the company's firewall/VPN could use Zeitmarket's secure communications to participate in the marketplace as provider or as client.

Enterprise licenses could be sold for fees based on the number of users and/or the amount of time they buy and sell and/or the value of all transactions. The underlying Zeitmarket service could be hosted and operated on behalf of the customer by the Zeitmarket management, or internally by the customer's IT department.

In addition to highly secure internal communication, the service provides Zeitmachine-based time management and automated cost determination and allocation among its staff members within the entire virtual corporate network including remote access and mobile communication devices. It provides a new social engineering and corporate management paradigm. The effects in a corporation of Zeitmachine-aided cost and reward allocation are impossible to predict at this time, but the potential benefits certainly warrant large scale experimentation.

### Vertical Markets

Zeitmarket and the Zeitmarket Corporate Edition can both be tailored to host specific vertical segments. An early vertical will probably be Software and Content Development.

### Software and Content Development

Stock photo sites like Getty Images license existing content to businesses and pay royalties to rights holders. Packaged software companies license ready-to-use code. But where can a company go to source bespoke content and code?

Today, businesses of all sizes in-source development to other divisions of their own company and/or outsource it domestically or internationally. But:
Creatives are far from interchangeable in terms of skill sets and work product quality. * Their business insurance status may not meet the company's requirements.
Before and after contracts are signed, they may use insecure connections to communicate with you.
For smaller projects, the time it takes to find developers, negotiate financial and legal terms and track the work can be as much or more than the time that engineering will take.

Zeitmarket makes software and content development more manageable. It helps to find qualified engineers using profile search, tells what price they command in the market and facilitates negotiations over scope and price. One can meet with developers remotely using Zeitmarket's secure communications and schedule those meetings using Zeitmarket's time-tracking calendar. Furthermore, the Zeitmarket Corporate Edition simplifies billing and payment whether interdepartmental or international.

To facilitate outsourced projects:
An exemplary practice of Zeitmarket can include the provision of legal agreements that cover a majority of situations. These agreements can be customized by choosing options on easy-to-understand forms or by enlisting legal service providers through Zeitmarket.
Zeitmarket offers developers and their customers escrow services to reduce the incidence of fraud and procrastination.
Through link-ups with leading insurers worldwide, Zeitmarket can help developers to find and purchase required policies. It can deduct premium payments from developer accounts to prevent most lapses and can ensure that customers are informed when lapses occur.

MINE Zero GmbH charges a commission on software and content development service fees, of fees for legal advice and of insurance policy premiums. It also charges escrow fees for software and content.

### The Private Internet

Z-Platform's highly secure and highly developed privacy system could evolve to support a legally compliant Private Internet that hosts services such as Private Web, Private Email, Private Text Messaging, Private File Storage, Private Search, and other private functions.

Through the common ZP services, Zeitmarket would enable websites to integrate with its secure/private services.

To use a private website, file store, chat room or any other addressed location a Z-Platform user, (thus a Zeitmarket member) can log in using the identity of any persona they own.

A location may be either secret (address discoverable only by communication with its owner) or published (address discoverable via search). Each user of the location may be given a different and unique address and password for that location. Any such discovered location may be visited using the unique address of that location. The owner may require a visitor to use their unique (persona) password to access the content.

A location owner may charge a fee to a persona who wishes to discover the location's address and/or enter the location. The fee is subject to commission payable to the company. The owner may set the amount of the fee but there may be an option to base the fee on the difference between the Levels of the owner's and user's personas.

The Zeitmarket management entity:
will know that a particular persona was using the Private Internet at a particular time for a particular length of time (metadata);
will know which members owned the personas involved (metadata)
will store metadata for the legally required time period;
will keep metadata secret unless forced by warrant to disclose;
will neither store addresses nor possess address decryption keys;
will neither store content nor possess content decryption keys.

Today, some social media platforms and other parties trace a user's Internet activity when the user visits their website or uses an app that they've instrumented. To enhance anonymity, Zeitmarket could allow any user of its Private Internet to visit any website of the public Internet and access its content without being traced by the public website's operator or any third party.

The Zeitmarket-based Private Internet compares with similar-sounding technologies in at least the following ways:
VPN: Like a Private Internet, a virtual private network is isolated from the public Internet, its addresses are invisible by default and metadata like connection time may be stored. But VPNs are known to be wide open for sophisticated continuous eavesdropping in real time.
Deep Web: Like a Private Internet. the Deep Web hides its sites and content from the general public. It is not designed to be legally compliant while providing privacy.
Tor: Like a Private Internet, Tor enables a user to transmit data anonymously over the Internet to and from Tor-enabled sites. It has failed to provide privacy as claimed and it is designed to be legally incompliant.

### Digital Currency

It is contemplated that Zeitmarket will be a digital adjunct to the worldwide service economy. Buyers will buy the time of sellers at rationally determined and economically justified rates that are consistent with traditional prices for similar time-based services. In an exemplary embodiment of the invention, they have the option to pay and be paid in Zeitmarket's internal digital currency based on the value of time which is universally established by the users qua their activities on Zeitmarket.

The new digital currency, referred to herein as “Zeitmark” or “Z-Mark”, is easily understandable, convenient, legally compliant, convertible to various traditional and digital currencies, and stable. Unlike other digital currencies, it is not grounded in the value of an artificially scarce, digital resource (such as certain hard-to-compute numbers) nor is it grounded in a naturally scarce, material resource (such as gold), or pegged to a traditional, real world currency.

Instead, the Zeitmark is grounded in the value of the available time of human beings. It is a fundamental, quantifiable and naturally scarce, immaterial resource. The value of the Zeitmark is algorithmically determined on Zeitmarket as an appropriate fraction of the total available time in a defined calendar-time interval of a “standard” user. In the limit of the acceptance of Zeitmarket as the universal platform for the provision and consumption of time, the currency Zeitmark will be grounded in the total available time of the world population.

### Glossary

Adversation A conversation involving a commercial message or other market research question that an advertiser initiates with a willing consumer. The advertiser pays the consumer for their attention.
Client Depending on context, either a customer of a provider or a Zeitmarket app that runs on a user's networked device.
Conversation A private communication session among Zeitmarket personas. It could include live audio/video in one or both directions, live chat and/or text message threads.
Level A fundamental persona attribute that is similar in concept to a frequent flyer program level or tier. The higher the Level:
   the smaller the population at that Level (elite status);
   the more plentiful the privileges (elite benefits);
   the higher the Zeitprice (elite income)
Persona An identity that a user assumes when transacting on Zeitmarket. It is similar in function to an AOL screen name or a Twitter handle. A user can have more than one persona, each displaying either their real name or a pseudonym.
Provider A persona able to provide a service through Zeitmarket to client personas.
   A verified provider is a non-anonymous provider whose identity and credentials Zeitmarket has accepted.
   A certified provider is a non-anonymous professional provider whose identity and professional credentials Zeitmarket has accepted.
Service Fee A fee that a client pays a provider to engage in a conversation. Zeitmarket collects the fee and keeps a percentage.
Subscriber A user who pays a recurring fee to Zeitmarket [if such a fee is applicable].
Success A metric value that rises when a provider fills more time slots with higher-paying customers.
Zeitprice The upper limit price that each provider can charge consumers. The Zeitprice scale is not continuous; it has thirteen discrete Levels.
   A new provider's Zeitprice is tentative if the provider has selected it. A tentative Zeirprice is subject to subsequent establishment by the Universal Zeitmachine following an initial period of evaluation and probation.
   A provider's established Zeitprice is the Zeitprice of a provider which has been established by the Universal Zcitmachine following an initial period of evaluation and probation or been established at regular, for example weekly, intervals on a rolling time window basis.
Zcitprice Algorithm A performance-based automated mechanism that calculates a fair Zeitprice for each provider based on their recent Success.
ZM An abbreviation for “Zeitmarket” used in internal documentation.
ZP An abbreviation for “Zeitmarket Platform” or “Z-Platform” referring to core platform services and modules on which Zeitmarket the application is built on.

### III. PRICING (“ZEITPRICE”) AND “UNIVERSAL ZEITMACHINE” (UZM) DESCRIPTION

A description of pricing (“Zeitprice”) and “Universal Zeitmachine” (UZM) aspects of the invention will next be set forth.

### ZeitPrice Overview

The fundamental underlying principle of Zeitmarket is that people's time has value for which they should be compensated when spent on someone else's behalf. To accomplish this, Zeitmarket provides a marketplace where an individual's time can be bought and sold. Zeitmarket continuously calculates the market price for the time of each provider. This market price is called the Zeitprice. The Zeitprice is the maximum chargeable price per time unit for a particular provider's persona.

Every provider in the system has their own Zeitmachine which helps to manage the provider's time and factors that feed that provider's Zeitprice.

The Zeitprice is determined by a server-based module called the Universal Zeitmachine (UZM).

The UZM determines each provider's Zeitprice based on data provided by each provider's individual Zeitmachine.

FIG. 6, discussed above, is a diagram showing the relationship of the Universal Zeitmachine components and modules 183 and the other platform components and modules.

### ZeitPrice Operation

In an exemplary embodiment, the Zeitprice calculation is based on algorithms involving Success factors, and relies on data provided by ZMCore/Zeitmachine, depicted in FIG. 6.

Referring again to FIG. 6, the Universal Zeitmachine software collects sales data (time slots offered, time slots purchased, prices paid) from the individual Zeitmachines and uses them and other factors to calculate Success, a metric that rises when a provider fills more time slots with higher-paying customers. Given the provider's current Level and their recent Success, the UZM algorithm decides whether to raise or lower the provider's Level or leave it alone. At each Level, there is a Zeitprice, which is the maximum amount the provider may charge for an hour of service to a consumer.

A new, underpaid provider may ascend a Level every month and then settle into a Level for many weeks, months or years before rising further or slipping down the scale. The difficulty of earning a higher Level may be dialed up or down by management to maintain a target percentage distribution that works best for consumers, providers, and Zeitmarket.

### Policies

The following are, for an exemplary practice of the invention, core policies that govern how Zeitprice is calculated:
There is a weekly determination of Zeitprice (provider's level).
There are target Professional and non-Professional provider distributions that define the Zeitprice for 11 and 13 levels, respectively.
Success=Productivity×Workload
Productivity=Actual Price/Zeitprice
Workload=number paid sessions/number offered sessions
If Success >SUCCESS_THRESHOLD for at least OBSERVATION_PERIOD weeks, provider moves up a level
If Success <(SUCCESS_THRESHOLD×LevelMinPrice/Zeitprice) for at least OBSERVATION_PERIOD weeks, provider goes down a level
A provider's initial level is normally determined by factors such as professional certification. Absent provable qualifications, the initial level can be set to the lowest possible level for providers. A provider who believes their time is worth more than that can choose a higher initial level but until it becomes “established” by the Zeitprice-setting mechanism the level and the Zeitprice will be labeled “tentative” wherever they are displayed.
The UZM software will offer providers guidance on ways to raise their Zeitprice.

### Uniqueness/Innovation

The ability to determine the maximum price for a service provider's time is unique and innovative.

UZM will allow global changes to occur across the entire Zeitmarket. For example, UZM will allow management to adjust the level of providers based on market conditions, seasonality, sponsorships, human behavior patterns, or other criteria based on simulations.

### Design Approach and Technical Implementation:

### UZM Scalability

The UZM is designed to take full advantage of event-based notifications which helps to allow for scalability millions of users.

Every persona's Zeitpricc is calculated weekly. The UZM is designed to do both recurring tasks like calculating Zeitprice and also to respond to a broad set of events. The term “event-based” also refers to the internal architecture of UZM.

UZM is designed for high performance with a goal of maximum response time in the tens of milliseconds, is written in C and employs appropriate optimization techniques.

UZM is extensible and modular by having well-defined APIs.

### Zeitpric Algorithm Changes

The Zeitprice algorithm is currently well-understood however we need to allow for changes in the future, as much as reasonably possible. We anticipate good API-design will assist with this form of extensibility.

We will allow for market-determined user behavior to influence the algorithm. Meaning, we will pay attention to how customers use the system and make changes to the algorithm as needed.

Some candidate additional feedback sources include provider quality metrics such as:
Amount of repeat business for a provider
Number of referrals a provider gets
Number of complaints a provider receives
Number of refunds a provider must provide
Punctuality of provider (did the sessions start on time?)

The UZM is architected to employ multiple algorithm that can be tested using standard A-B testing techniques.

### Virtual Actors

The UZM system has been designed to incorporate virtual actors, or “bots,” that can exhibit some of the behaviors of real users in the system. These virtual actors can be quite useful in testing various aspects of our overall system infrastructure by simulating real-world behavior.

Interaction with Zeitmachines

The UZM needs to act on provider performance data in order to calculate new weekly Zeitprices for all the providers. UZM will do this by issuing Protobuf requests over https to a ZMCore-specific endpoint. The ZMCore will respond to the request with the provider performance data requested.

On a weekly basis, once UZM has calculated new Zeitpriccs for the providers, UZM will issue JSON requests over http to a ZMCore-specific endpoint for the purpose of sending new Zeitprices to ZMCore. JSON may not be the best approach from a performance perspective and that's noted in the open issues below.

At the same time as when UZM updates the ZMCore with new Zeitprices, UZM will inform ZMCore of specific instructions or advice on how each provider can improve her Zeitprice.

In an exemplary embodiment, the UZM runs on regular production server infrastructure, “parallel” to ZMCore, because UZM needs to communicate most efficiently with ZMCore. In an exemplary embodiment, in each environment such as production, stage, etc., there will be one instance of UZM running on a VM; and there will be a Postgres cluster on the same subnet for persistence of data that UZM needs to persist. An exemplary embodiment may utilizes hot standby for failover protection and performance of backups. A further exemplary embodiment may start with two nodes in the cluster and expand as needed.

Communication content/frequency

In addition to the above UZM-ZMCore interactions, there are also the following communication needs:
Possible communication with an e-commerce data store (if different from ZMCore) in order to calculate Zeitprice weekly.
UZM will need to talk to the BI infrastructure so that platform management can view status of the Zeitmarket and/or other internal systems.
Other platform management systems may be able to communicate with UZM on an ad-hoc basis with UZM acting as a server. Such requests are likely to include things such as platform management personnel querying to see when a particular provider's Zeitprice was last updated.

### Provider Dashboard

In an exemplary embodiment, as part of the Zeitmarket user interface, there will be an area called the “provider dashboard” that is a status page for the provider where she can see various attributes of her account. In such an embodiment, UZM can provide inputs such as the following inputs to the provider dashboard:
Custom messages for the provider that will indicate how she can raise her Zeitprice.
Useful overall statistics such as “77% of the providers at your level arrived there in the past year.” (for non-base level providers).
The information UZM provides will be sent from UZM to ZMCore, where ZMCore will make it available to the provider in the normal manner. UZM will not directly communicate with the provider's user interface.

### UZM-Zeitmachine Usage & System Monitoring

In an exemplary embodiment, only platform management personnel specifically authorized to interact with UZM will be allowed to, whether at the command-line or through a GUI.

In an exemplary embodiment there will be a GUI through which an authenticated platform management employee can view statistics about Zeitmarket overall. Likely information shown will include number of providers at each level and recent level-movement statistics.

In an exemplary embodiment, the Zeitmarket information that can be changed by such a person could be limited to the Success Threshold (the difficulty or ease with which a provider can move up or down a level) and the Observation Period (the number of weeks of historical data taken into account when calculating Zeitprice)

An exemplary embodiment may utilize some amount of UZM-BI system integration. Live, real-time connectivity and reporting are likely to be useful.

### Exception Handling

An exemplary embodiment may allow certain providers to stay at a certain level regardless of their performance. There are several situations that may be relevant:
When providers go on holiday, UZM needs to take the absence into account and not allow the provider to fall a level due to the absence. The performance of the provider may appear to be very poor for the relevant time period, but that would be due to a situation of “zero activity” and that, during a vacation period, should not be a reason for a provider's level to fall.
Providers may wish to take a break from Zeitmarket, be busy with other life activities, or just want to pop-in and pop-out of Zeitmarket on an engagement basis. In these situations, the typical Zeitprice calculation discussed elsewhere herein will tend to push the provider's level down. Many of these providers will ask to retain their Zcitprice/level, and they should and can be accommodated.
It is noted, however, that some Members may resent this “special” treatment of others.
Also, Members may resent their Zeitprice being lowered because they were not engaging with Zeitmarket in the way the Zeitprice algorithm wants them to.

### IV. DIGITAL PROCESSING ENVIRONMENT IN WHICH INVENTION CAN BE IMPLEMENTED

The following is a discussion of digital processing structures and environments in which the invention may be implemented and practiced. It will be understood that the recitations of the claims shall control the scope of the invention, and nothing in the following discussion shall be construed in any manner contrary to or limiting of the claimed invention.

It will be understood by those skilled in the art that the present invention provides methods, systems, devices and computer program products that can be implemented as part of the computer software or computer hardware of a digital communications network, which may include digital processors, computers, “smartphones”, tablet computers, or other computing devices, which may include mobile computing devices, that form part of a computer network or telecommunications network, along with memory, storage, and other conventional computer system or telecommunications system components. While conventional components of such kinds are well known to those skilled in the art, and thus need not be described in great detail herein, the following overview indicates how the present invention can be implemented in conjunction with such components.

It will also be understood by those skilled in the art that aspects of the invention can be implemented in software, hardware, or a combination of software and hardware, using otherwise conventional network architectures and digital processing apparatus including devices such as servers, personal computers (PC), smartphones, tablet computers, or equivalent devices operating in accordance with (or emulating) a conventional operating system such as iOS, Microsoft Windows, Linux, Android, or other, either in a standalone configuration or across a network. The various processing aspects and means described herein may therefore be implemented in the software and/or hardware elements of a properly configured digital processing device or network of devices. Processing may be performed sequentially or in parallel, and may be implemented using special purpose or re-configurable hardware.

Various aspects of the invention can be embodied at least in part in commercially available servers, PC's, tablet computers, smartphones or other mobile computing platform that contains functional elements suitable for implementation of the invention. A commercially available server, for example, suitable for implementation of aspects of the invention can include, for example, one or more processor, memory and mass storage devices, such as disk storage elements, which perform processing and storage operations in connection with digital data provided thereto.

As used herein, the terms “memory”, “storage” and “disk storage devices” and the like can encompass any computer readable medium, such as a computer hard disk, computer floppy disk, computer-readable flash drive, computer-readable RAM or ROM element or any other known means of encoding digital information. The term “applications programs”, “applications”, “apps”, “programs”, “computer program product” or “computer software product” can encompass any computer program product consisting of computer-readable programs instructions encoded and/or stored on a computer readable medium, whether that medium is fixed or removable, permanent or erasable, or otherwise Applications and data can be stored on a disk, in RAM, ROM, on other removable or fixed storage, whether internal or external, and can be downloaded or uploaded, in accordance with practices and techniques well known in the art. As will also be noted in this document, the present invention can take the form of software or a computer program product stored on a computer-readable medium, or it can be in the form of computer program code that can be uploaded or downloaded, or fixed in a ROM or other electronic structure, or it can take the form of a method or a system for carrying out such a method.

In addition, the digital processors, processing modules, servers and other processing structures discussed herein can include one or more network ports connected to communication links or channels which allow communication with, and within, a network, in accordance with known digital network practice, wherein a given processor or module can transmit information, content, data or requests to, and receive information, content, data or requests from, other computer systems and other devices in the network. In a typical network organized according to, for example, a conventional client-server paradigm, certain computer systems in the network may be designated as servers, which store data and programs (generally, “information”) for processing by the other, client computer systems. A client computer system that needs access to information maintained by a particular server can request, enable or cause the server to download the information to it over the network. After processing the data, the client computer system may also return processed data to the server for storage. In addition to computer systems (including the above-described servers and clients), a network may also include, for example, other resources which may be shared among the various computer systems connected in the network.

The communication links interconnecting the computer systems in the network may comprise any convenient information-carrying medium, including wires, optical fibers or other media for carrying signals among the computer systems. Computer systems transfer information over the network by means of messages transferred over the communication links, with each message including information and an identifier identifying the device to receive the message.

Systems, devices or software products in accordance with the present invention can operate on any of a wide range of conventional computing devices, systems and architectures, whether standalone, networked, portable or fixed, including conventional PCs, laptop computers, handheld or mobile computers, smartphones, tablets, or across the Worldwide Web (“the Web”), Internet or other networks, which may in turn include servers and storage devices and systems. Alternatively, aspects of the invention can be embodied at least in part in a commercially available smartphone, tablet computer or other mobile device that contains functional elements equivalent to those noted above.

In accord with conventional computer software and hardware practice, software applications configured in accordance with the invention can operate within, e.g., a PC or server, or known forms of handheld computing devices, smartphones or tablet computers, in which program instructions can be read from ROM or CD ROM, magnetic disk or other storage and loaded into RAM for execution by a processor such as a CPU. Data can be input into the system via any known device or means, including a conventional keyboard, mouse, scanner, digitizing tablet, or other elements. Applications and/or data can be located on some or all of fixed or removable storage or ROM, or downloaded.

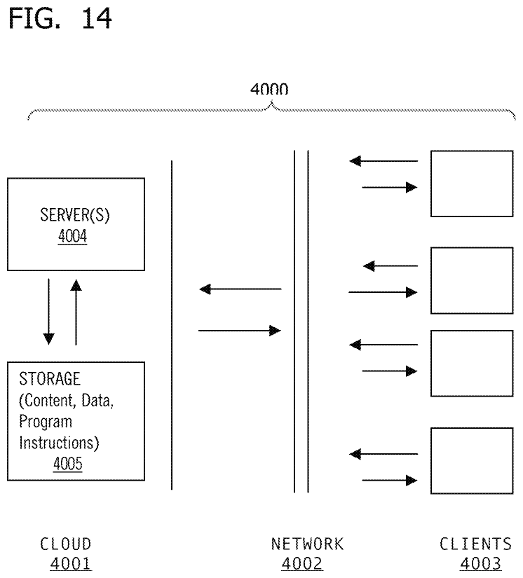

The invention can also be implemented in association with a cloud computing architecture. By way of background and example. FIG. 14 is a diagram of one form (although not the only form) of cloud configuration 4000 in connection with which the invention can be implemented, comprising a cloud layer 4001, a network layer 4002, and a client layer 4003. Program instructions or software applications contained in storage 4005 within the cloud layer 4001 are accessible by servers 4004 that communicate via network 4002 with individual clients in the client layer 4003. It will be understood that the invention can be implemented in connection with configurations and architectures other than cloud configurations, and other than that shown in FIG. 14.

As implementation platforms, client operating systems can include known forms of iOS, MacOS, Android. Windows, and Linux/Unix operating systems; and the server operating systems include known forms of Linux/Unix and MacOS operating systems. Those skilled in the relevant art will understand and appreciate that the invention can be implemented on a wide range of current computing systems.

Those skilled in the art will understand that aspects of the invention described herein can be executed in hardware elements, such as at the server level, or at a microprocessor level, such as within a Field-Programmable Gate Array (FPGA) or an Application-Specific Integrated Circuit (ASIC) constructed specifically to carry out the processes described herein, using ASIC construction techniques known to ASIC manufacturers. The actual semiconductor elements of a conventional ASIC or equivalent integrated circuit are not part of the present invention, and will not be discussed in detail herein. Alternatively, general-purpose processors can be used to execute aspects of the invention.

Those skilled in the art will understand that the above described embodiments, practices and examples of the invention can be implemented using known forms of communications or digital processing networks, computer processors and telecommunications devices, in which the telecommunications devices can include known forms of cellphones, smartphones, and other known forms of mobile devices, tablet computers, desktop and laptop computers, and known forms of digital network components and server/cloudlnetwork/client architectures that enable communications between such devices.

Those skilled in the art will also understand that method aspects of the present invention can be executed within commercially available digital processing devices and systems, such as servers, PC's, laptop computers, tablet computers, personal computers (PCs) and smartphones or other mobile devices, operating under the collective command of the smartphones or computer's operating system, such as iOS, Android or Windows, and a computer program product configured in accordance with the present invention, as well as known forms of digital networks, including architectures comprising server, cloud, network, and client aspects, for communications between such devices.

The terms “computer software,” “computer code product,” and “computer program product” as used herein can encompass any set of computer-readable programs instructions encoded on a non-transitory computer readable medium. A computer readable medium can encompass any form of computer readable element, including, but not limited to, a computer hard disk, computer floppy disk, computer-readable flash drive, computer readable RAM or ROM element, or any other known means of encoding, storing or providing digital information, whether local to or remote from the workstation, PC or other digital processing device or system. Various forms of computer readable elements and media are well known in the computing arts, and their selection is left to the implementer.

In addition, those skilled in the art will understand that the invention can be implemented using computer program modules and digital processing hardware elements, including memory units and other data storage units, including commercially available processing units, memory units, computers, servers, smartphones, tablet computers and other computing and telecommunications devices, including mobile devices. The term “modules”, “program modules”, “components”, and the like include computer program instructions, objects, components, data structures, and the like that can be executed to perform selected tasks or achieve selected outcomes. The various modules shown in the drawings and discussed in the description herein refer to computer-based or digital processor-based elements that can be implemented as software, hardware, firmware and/or other suitable components, taken separately or in combination, that provide the functions described herein, and which may be read from computer storage or memory, loaded into the memory of a digital processor or set of digital processors, connected via a bus, a communications network, or other communications pathways, which, taken together, constitute an embodiment of the present invention.

The terms “data storage module”, “data storage element”, “memory element” and the like, as used herein, can refer to any appropriate memory element usable for storing program instructions, machine readable files, databases, and other data structures. The various digital processing, memory and storage elements described herein can be implemented to operate on a single computing device or system, such as a server or collection of servers, or they can be implemented and inter-operated on various devices across a network, whether in a server-client arrangement, server-cloud-client arrangement, or other configuration in which client devices can communicate with allocated resources, functions or applications programs, or with a server, via a communications network.

It will also be understood that computer program instructions suitable for a practice of the present invention can be written in any of a wide range of computer programming languages, including Java, C++, and the like. It will also be understood that method operations shown in the flowcharts can be executed in different orders, and that not all operations shown need be executed, and that many other combinations of method operations are within the scope of the invention as defined by the attached claims. Moreover, the functions provided by the modules and elements shown in the drawings and described in the foregoing description can be combined or sub-divided in various ways, and still be within the scope of the invention as defined by the attached claims.

### Flowcharts of Exemplary Practices of the Invention

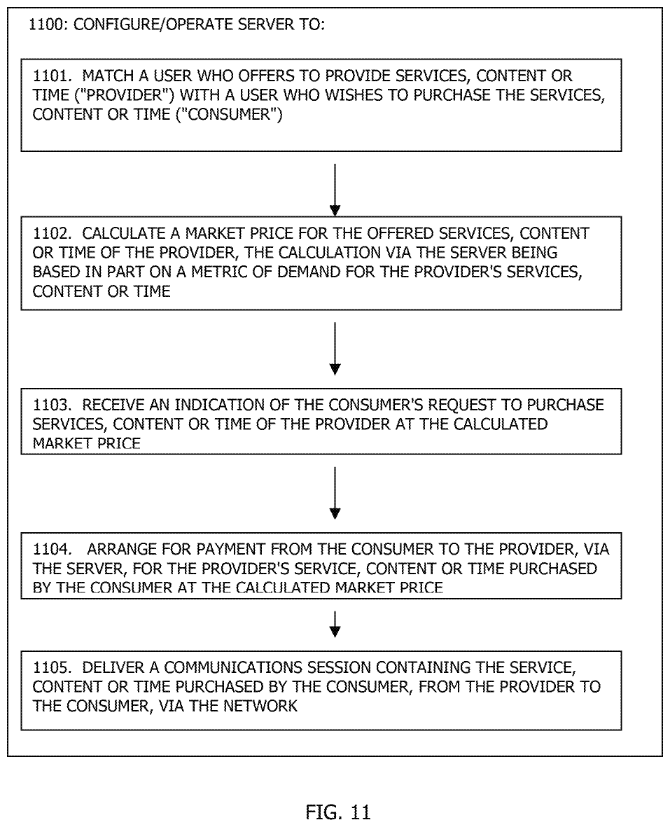

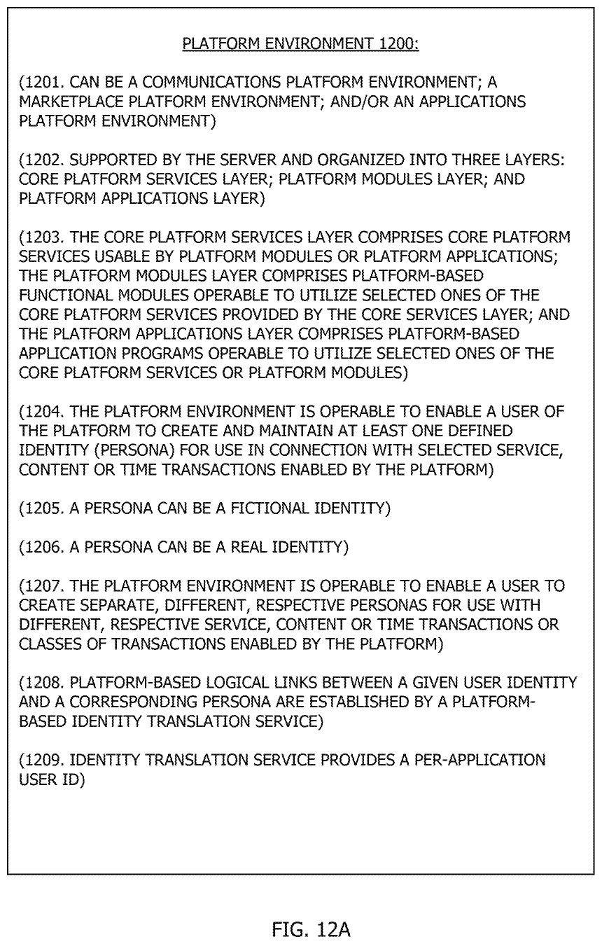

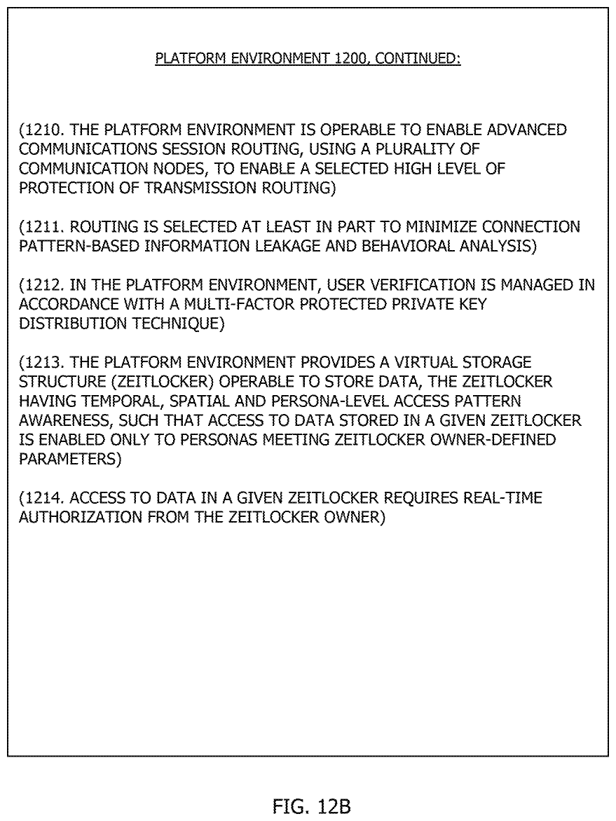

FIGS. 11, 12A and 12B are flowcharts illustrating exemplary method aspects and practices of the invention. The method aspects depicted in this flowchart are examples only; the organization, order and number of operations in the exemplary practices can be varied; and the exemplary practices and methods can be arranged or ordered differently, and include different functions, whether singly or in combination, while still being within the spirit and scope of the present invention.

Items shown in FIGS. 11, 12A and 12B in parentheses, or described below in parentheses, are, among other aspects, optional in a given practice of the invention.

In particular, FIG. 11 shows a method 1100 according to an exemplary practice of the invention. including the following operations:

1100: Configure/operate the server to:
1101. Match a user who offers to provide services, content or time (referred to herein as a “Provider”) with a user who wishes to purchase the services, content or time (referred to herein as a “Consumer”);
1102. Calculate a market price for the offered services, content or time of the Provider, the calculation via the server being based in part on a metric of demand for the Provider's services, content or time;
1103. Receive an indication of the Consumer's request to purchase services, content or time of the Provider at the calculated market price;
1104. Arrange for payment from the Consumer to the Provider, via the server, for the Provider's service, content or time purchased by the Consumer at the calculated market price; and
1105. Deliver a communications session containing the service, content or time purchased by the Consumer, from the Provider to the Consumer, via the network.

FIGS. 12A and 12B illustrate aspects of the platform environment 1200, as follows (wherein items shown in FIGS. 12A or 12B in parentheses, or described below in parentheses, are, among other aspects, optional in a given practice of the invention):

### Platform Environment 1200:

(1201. Can be a communications platform environment; a marketplace platform environment; and/or an applications platform environment.)
(1202. Is supported by the server and organized into three layers: Core Platform Services layer; Platform Modules layer, and Platform Applications layer.)
(1203. The Core Platform Services layer comprises core platform services usable by platform modules or platform applications; the Platform Modules layer comprises platform-based functional modules operable to utilize selected ones of the core platform services provided by the core services layer; and the Platform Applications layer comprises platform-based application programs operable to utilize selected ones of the core platform services or platform modules.)
(1204. The platform environment is operable to enable a user of the platform to create and maintain at least one defined identity (referred to herein as a Persona) for use in connection with selected service, content or time transactions enabled by the platform.)
(1205. A Persona can be a fictional identity.)
(1206. A Persona can be a real identity.)
(1207. The platform environment is operable to enable a user to create separate, different, respective Personas for use with different, respective service, content or time transactions or classes of transactions enabled by the platform.)
(1208. Platform-based logical links between a given user identity and a corresponding Persona are established by a platform-based identity translation service (ITS).)
(1209. The Identity Translation Service (ITS) provides a per-application user ID.)
(1210. The platform environment is operable to enable advanced communications session routing, using a plurality of communication nodes, to enable a selected high level of protection of transmission routing.)
(1211. Routing is selected at least in part to minimize connection pattern-based information leakage and behavioral analysis.)
(1212. In the platform environment, user verification is managed in accordance with a multi-factor protected private key distribution (MFPPKD) technique.)
(1213. The platform environment provides a virtual storage structure (referred to herein as a Zeitlocker) operable to store data, the Zeitlocker having temporal, spatial and Persona-level access pattern awareness, such that access to data stored in a given Zeitlocker is enabled only to Personas meeting Zeitlocker owner-defined parameters.)
(1214. Access to data in a given Zeitlocker requires real-time authorization from the designated Zeitlocker owner or Zeitlocker owner Persona(s).)

### Block Diagram of Exemplary Embodiment of the Invention

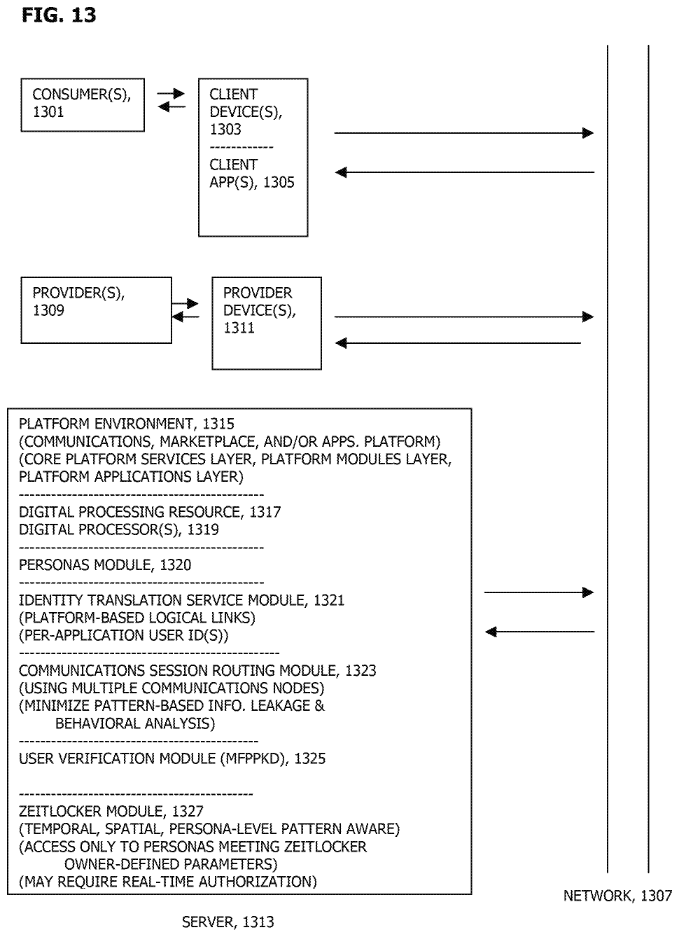

FIG. 13 is a schematic block diagram depicting an exemplary embodiment of the invention, in the form of a system 1300 that enables a Provider (or Providers) 1309 to sell services, content or time to a Consumer (or Consumers) 1301 via a digital communications network 1307 and to be financially compensated for the value of the services, content or time provided, via a digital communications network 1307. FIG. 13 depicts a server 1313 accessible to a plurality of users (Consumer(s) 1301) through respective client application programs (“apps”) 1305 executing on respective client devices 1303 capable of communicating with the server 1313 via a digital communications network 1307, the server 1313 comprising a digital processing resource 1317, the digital processing resource 1317 comprising at least one digital processor 1319. In the example of FIG. 13, the client device(s) 1303 can be computers, smartphones, tablets, or other known digital communications and processing devices. In the example of FIG. 13, the Provider(s) communicate with the server 1313 via the network 1307, and communicate with the network 1307 through corresponding provider device(s) 1311, which may be computers, smartphones, tablets, or other known digital communications and processing devices. The communications links between these elements, depicted with arrows in FIG. 13, can be of known design.

As discussed in greater detail elsewhere herein, in accordance with exemplary embodiments of the invention, the server 1313 is operable to: (A) match a user who offers to provide services, content or time (“Provider” 1309) with a user who wishes to purchase the services, content or time (“Consumer” 1301); (B) calculate a market price for the offered services, content or time of the Provider, the calculation via the server being based in part on a metric of demand for the Provider's services, content or time; (C) receive an indication of the Consumer's request to purchase services, content or time of the Provider at the calculated market price; (D) arrange for payment from the Consumer to the Provider, via the server, for the Provider's service, content or time purchased by the Consumer at the calculated market price; and (E) deliver a communications session containing the service, content or time purchased by the Consumer, from the Provider to the Consumer, via the network.

As also depicted in FIG. 13, the server 1313 supports a platform environment 1315, which can be a communications platform environment, marketplace platform environment, and/or applications platform environment; and the platform environment, in the illustrated embodiment, is organized into three layers, comprising a core platform services layer, a platform modules layer, and a platform applications layer. As discussed in greater detail elsewhere herein, the core platform services layer comprises core platform services usable by platform modules or platform applications; the platform modules layer comprises platform-based functional modules operable to utilize selected ones of the core platform services provided by the core services layer; and the platform applications layer comprises platform-based application programs operable to utilize selected ones of the core platform services or platform modules.

As also depicted in FIG. 13, the server 1313 contains, supports or provides a Persona(s) module 1320, and as discussed in greater detail elsewhere herein, the platform environment 1315 is operable to enable a User of the platform to create and maintain at least one defined identity (Persona) for use in connection with selected service, content or time transactions enabled by the platform. Also as discussed herein, a Persona can be a fictional identity. Alternatively, a Persona can be a real identity (e.g., an identity that correlates in an identifiable manner with a real-world identity).

Through the functions of the server 1313, the platform environment 1315 is operable to enable a User to create separate, different, respective Personas for use with different, respective service, content or time transactions or classes of transactions enabled by the platform.

As shown in FIG. 13, the server 1313 also provides an Identity Translation Service (ITS) module 1321 for providing Identity Translation Service (ITS), and as discussed herein, platform-based logical links between a given User identity and a corresponding Persona are established by the platform-based Identity Translation Service (ITS) provided by the ITS module 1321. As also discussed herein, the ITS can provide a per-application user ID.

As also shown in FIG. 13, the server 1313 also provides a communications session routing module 1323; and in an exemplary embodiment of the invention, the platform environment 1315, through the functions of the server 1313, is operable to enable advanced communications session routing, using a plurality of communication nodes, to enable a selected high level of protection of transmission routing. As also discussed elsewhere herein, in an exemplary embodiment, routing is selected at least in part to minimize connection pattern-based information leakage and behavioral analysis.

As also shown in FIG. 13, server 1313 provides a user verification module 1325, and in an exemplary embodiment, in connection with the platform environment 1315 supported by the server 1313, user verification is managed in accordance with a multi-factor protected private key distribution (MFPPKD) technique.

As also shown in FIG. 13, server 1313 provides a Zeitlocker module 1327, and in an exemplary embodiment, the platform environment 1315 supported by the server 1313. provides a virtual storage structure (Zeitlocker) operable to store data, the Zeitlocker having temporal, spatial and Persona-level access pattern awareness, such that access to data stored in a given Zeitlocker is enabled only to Personas meeting Zeitlocker owner-defined parameters. In an exemplary practice of the invention, access to data in a given Zeitlocker requires real-time authorization from the Zeitlocker owner.

The various modules shown in FIG. 13 that are supported by or provided by the server can consist of digital hardware, software, or a combination of digital hardware on which software applications, programs or instructions are executing. The modules can be structural, functional, or be characterized by a combination of structural and/or functional aspects.

The server(s), client device(s), communications links (schematically denoted by arrows in FIG. 13) and network shown in FIG. 13, by way of example, can be of generally conventional construction, and can be provided by use of commercially available servers, computers, smartphones, tablets, and other such communications and processing devices, provided such structures, devices, and networks are configured and operated in accordance with the present invention. The server or servers can include or be in communication with known forms of digital storage, in accordance with known techniques of server design.

In FIG. 13, the Provider(s) are shown as communicating with the server(s) through their corresponding provider devices and through the network. Alternatively, the Provider(s) may communicate with the server(s) through a different network, or may communicate with one or more servers more directly, without the use of a network.

The platform environment (whether a communications, marketplace, and/or applications platform environment) is depicted in FIG. 13 as being within, and supported by, the server. Alternatively, the platform environment could be collectively supported by more than one server and its digital processing resources; and could also be considered to include functional and/or structural aspects of the Provider(s)' devices and/or the User(s)' client devices, depending on the selected allocation of processing operations. Decisions as to selected allocation of processing operations within a networked configuration are left to implementers of the present invention.

### V. CONCLUSION

While the foregoing description and the accompanying drawing figures provide details that will enable those skilled in the art to practice aspects of the invention, it should be recognized that the description is illustrative in nature and that many modifications and variations thereof will be apparent to those skilled in the art having the benefit of these teachings. It is accordingly intended that the invention herein be defined solely by any claims that may be appended hereto and that the invention be interpreted as broadly as permitted by the prior art.

We claim:

1. A system that enables a provider to sell services, content or time to a consumer via a digital network and be financially compensated for the value of the services, content or time provided, the system comprising:
a server accessible to a plurality of users through respective client application programs executing on respective client devices capable of communicating with the server via a digital network, the server comprising a digital processing resource, the digital processing resource comprising at least one digital processor, the server being operable to:
(A) match a user who offers to provide services, content or time (“Provider”) with a user who wishes to purchase the services, content or time (“Consumer”);
(B) calculate a market price for the offered services, content or time of the Provider, the calculation via the server being based in part on a metric of demand for the Provider's services, content or time;
(C) receive an indication of the Consumer's request to purchase services, content or time of the Provider at the calculated market price;
(D) arrange for payment from the Consumer to the Provider, via the server, for the Provider's service, content or time purchased by the Consumer at the calculated market price; and
(E) deliver a communications session containing the service, content or time purchased by the Consumer, from the Provider to the Consumer, via the network.

2. The system of claim 1 further comprising:
a communications platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

3. The system of claim 1 further comprising:
a marketplace platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

4. The system of claim 1 further comprising:
an application platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

5. The system of claim 2, 3 or 4 wherein the platform environment is operable to enable a User of the platform to create and maintain at least one defined identity (Persona) for use in connection with selected service, content or time transactions enabled by the platform.

6. The system of claim 5 wherein a Persona is a fictional identity.

7. The system of claim 5 wherein a Persona is a real identity.

8. The system of claim 5 wherein the platform environment is operable to enable a User to create separate, different, respective Personas for use with different, respective service, content or time transactions or classes of transactions enabled by the platform.

9. The system of claim 8 wherein platform-based logical links between a given User identity and a corresponding Persona are established by a platform-based Identity Translation Service (ITS).

10. The system of claim 9 wherein the ITS provides a per-application user ID.

11. The system of any of claims 2-10 wherein the platform environment is operable to enable advanced communications session routing, using a plurality of communication nodes, to enable a selected high level of protection of transmission routing.

12. The system of claim 11 wherein routing is selected at least in part to minimize connection pattern-based information leakage and behavioral analysis.

13. The system of any of claims 2-12 wherein, in the platform environment, user verification is managed in accordance with a multi-factor protected private key distribution technique.

14. The system of claim 13 wherein the platform environment provides a virtual storage structure (Zeitlocker) operable to store data, the Zeitlocker having temporal, spatial and Persona-level access pattern awareness, such that access to data stored in a given Zeitlocker is enabled only to Personas meeting Zeitlocker owner-defined parameters.

15. The system of claim 14 wherein access to data in a given Zeitlocker requires real-time authorization from the Zeitlocker owner.

16. A method for enabling a provider to sell services, content or time to a consumer via digital network and be financially compensated for the value of the services, content or time provided, the method comprising:
configuring a server accessible to a plurality of users through respective client application programs executing on respective client devices capable of communicating with the server via a digital network, the server comprising a digital processing resource, the digital processing resource comprising at least one digital processor, and
operating the server to:
(A) match a user who offers to provide services, content or time (“Provider”) with a user who wishes to purchase the services, content or time (“Consumer”);
(B) calculate a market price for the offered services, content or time of the Provider, the calculation via the server being based in part on a metric of demand for the Provider's services, content or time;
(C) receive an indication of the Consumer's request to purchase services, content or time of the Provider at the calculated market price;
(D) arrange for payment from the Consumer to the Provider, via the server, for the Provider's service, content or time purchased by the Consumer at the calculated market price; and
(E) deliver a communications session containing the service, content or time purchased by the Consumer, from the Provider to the Consumer, via the network.

17. The method of claim 16 further comprising:
configuring a communications platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer, and
the platform applications layer comprises platform-based application programs operable to utilize selected ones of the core platform services or platform modules.

18. The method of claim 16 further comprising:
a marketplace platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer, and
the platform applications layer comprises platform-based application programs operable to utilize selected ones of the core platform services or platform modules.

19. The method of claim 16 further comprising:
an application platform environment supported by the server and organized into three layers. comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

20. The method of claim 17, 18 or 19 wherein the platform environment is operable to enable a User of the platform to create and maintain at least one defined identity (Persona) for use in connection with selected service, content or time transactions enabled by the platform.

21. The method of claim 20 wherein a Persona is a fictional identity.

22. The method of claim 20 wherein a Persona is a real identity.

23. The method of claim 20 wherein the platform environment is operable to enable a User to create separate, different, respective Personas for use with different, respective service, content or time transactions or classes of transactions enabled by the platform.

24. The method of claim 23 wherein platform-based logical links between a given User identity and a corresponding Persona are established by a platform-based Identity Translation Service (ITS).

25. The method of claim 24 wherein the ITS provides a per-application user ID.

26. The method of any of claims 17-25 wherein the platform environment is operable to enable advanced communications session routing, using a plurality of communication nodes, to enable a selected high level of protection of transmission routing.

27. The method of claim 26 wherein routing is selected at least in part to minimize connection pattern-based information leakage and behavioral analysis.

28. The method of any of claims 17-27 wherein, in the platform environment, user verification is managed in accordance with a muli-factor protected private key distribution technique.

29. The method of claim 28 wherein the platform environment provides a virtual storage structure (Zeitlocker) operable to store data, the Zeitlocker having temporal, spatial and Persona-level access pattern awareness, such that access to data stored in a given Zeitlocker is enabled only to Personas meeting Zeitlocker owner-defined parameters.

30. The method of claim 29 wherein access to data in a given Zeitlocker requires real-time authorization from the Zeitlocker owner.

31. A computer program product for use with a digital processing system for enabling a provider to sell services, content or time to a consumer via digital network and be financially compensated for the value of the services, content or time provided, the digital processing system comprising a server, the server comprising at least one digital processor, the server being accessible to a plurality of users through respective client application programs executing on respective client devices operable to communicate with the server via a digital network, the computer program product comprising digital processor-executable program instructions stored on a non-transitory digital processor-readable medium, which when executed in the digital processor cause the server to:
(A) match a user who offers to provide services, content or time (“Provider”) with a user who wishes to purchase the services, content or time (“Consumer”);
(B) calculate a market price for the offered services, content or time of the Provider, the calculation via the server being based in part on a metric of demand for the Provider's services, content or time;
(C) receive an indication of the Consumer's request to purchase services, content or time of the Provider at the calculated market price;
(D) arrange for payment from the Consumer to the Provider, via the server, for the Provider's service, content or time purchased by the Consumer at the calculated market price; and
(E) deliver a communications session containing the service, content or time purchased by the Consumer, from the Provider to the Consumer, via the network.

32. The program product of claim 31 further comprising digital processor-executable program instructions which when executed in the digital processor cause the server to:
configure a communications platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

33. The program product of claim 31 further comprising digital processor-executable program instructions which when executed in the digital processor cause the server to:
configure a marketplace platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer, and
the platform applications layer comprises platform-based application programs operable to utilize selected ones of the core platform services or platform modules.

34. The program product of claim 31 further comprising digital processor-executable program instructions which when executed in the digital processor cause the server to:
configure an application platform environment supported by the server and organized into three layers, comprising a core platform services layer, a platform modules layer, and a platform applications layer, wherein:
the core platform services layer comprises core platform services usable by platform modules or platform applications;
the platform modules layer comprises platform-based functional modules operable to utilize selected ones of the core platform services provided by the core services layer; and
the platform applications layer comprises platform-based application programs operable to utilize selected ones of the core platform services or platform modules.

35. The program product of claim 32, 33 or 34 wherein the platform environment is operable to enable a User of the platform to create and maintain at least one defined identity (Persona) for use in connection with selected service, content or time transactions enabled by the platform.

36. The program product of claim 35 wherein a Persona is a fictional identity.

37. The program product of claim 35 wherein a Persona is a real identity.

38. The program product of claim 35 wherein the platform environment is operable to enable a User to create separate, different, respective Personas for use with different, respective service, content or time transactions or classes of transactions enabled by the platform.

39. The program product of claim 38 wherein platform-based logical links between a given User identity and a corresponding Persona are established by a platform-based Identity Translation Service (ITS).

40. The program product of claim 39 wherein the ITS provides a per-application user ID.

41. The program product of any of claims 32-40 wherein the platform environment is operable to enable advanced communications session routing, using a plurality of communication nodes, to enable a selected high level of protection of transmission routing.

42. The program product of claim 41 wherein routing is selected at least in part to minimize connection pattern-based information leakage and behavioral analysis.

43. The program product of any of claims 32-42 wherein, in the platform environment, user verification is managed in accordance with a multi-factor protected private key distribution technique.

44. The program product of claim 43 wherein the platform environment provides a virtual storage structure (Zeitlocker) operable to store data, the Zeitlocker having temporal, spatial and Persona-level access pattern awareness, such that access to data stored in a given Zeitlocker is enabled only to Personas meeting Zeitlocker owner-defined parameters.

45. The program product of claim 44 wherein access to data in a given Zeitlocker requires real-time authorization from the Zeitlocker owner.
